(19) United States
(12) Patent Application Publication
(10) Pub. No.: US 2008/0016049 A1
(43) Pub. Date: Jan. 17, 2008

(54) NATURAL LANGUAGE SUPPORT FOR QUERY RESULTS

(76) Inventors: Richard D. Dettinger, Rochester, MN (US); Janice R. Glowacki, Rochester, MN (US); Frederick A. Kulack, Rochester, MN (US); Erik E. Voldal, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/456,940

(22) Filed: Jul. 12, 2006

(51) Int. Cl. G06F 17/30

(52) U.S. Cl. 707/4

(57) ABSTRACT

A method, system and article of manufacture for providing language transformation support for a query result obtained in response to execution of a query against an underlying database containing physical data. The method comprises identifying one or more physical values defined by the physical data for the query result for the executed query. The method further comprises retrieving a user-defined function configured to transform the one or more identified physical values from a first language defined by the physical data in the underlying database into alternative values defined in a second language. The query result is outputted in the second language on the basis of the user-defined function.

### REFERENCE TO CROSS-RELATED APPLICATIONS

This application is related to the following commonly owned applications: U.S. patent application Ser. No. 10/083,075, filed Feb. 26, 2002, entitled “Application PORTABILITY AND EXTENSIBILITY THROUGH Database Schema and Query Abstraction”, and U.S. patent application Ser. No. 10/718,218, filed Nov. 20, 2003, entitled “NATURAL LANGUAGE SUPPORT FOR DATABASE APPLICATIONS”, which are hereby incorporated herein in their entirety.

### BACKGROUND OF THE INVENTION

1. Field of the Invention

The present invention generally relates to data processing in databases and, more particularly, to providing natural language support for users running queries against a database.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, a DBMS can be structured to support a variety of different types of operations for a requesting entity (e.g., an application, the operating system or an end user). Such operations can be configured to retrieve, add, modify and delete information being stored and managed by the DBMS. Standard database access methods support these operations using high-level database query languages, such as the Structured Query Language (SQL).

One type of functionality that a DBMS must support for end users is natural language support. By way of example, one framework provides natural language support for users running queries in an abstract database environment. The abstract database environment provides a requesting entity (i.e., an end-user or front-end application) with a data abstraction model that defines an abstract representation of data stored in an underlying physical storage mechanism, such as a relational database. The framework provides a natural language resource component that defines translation information for a given data abstraction model using one or more natural language expressions. The natural language expression(s) can be used to translate default language expressions occurring in an abstract query that is created using the given data abstraction model into another language defined by the natural language resource component.

One drawback of the foregoing framework is that only components of an abstract query including the query's inputs, outputs and conditions, can be translated from an underlying default language into a predefined natural language. However, query results that are obtained for the abstract query using the framework are output in the underlying default language.

Therefore, there is a need for an improved and more flexible technique for providing natural language support for users running queries against a database.

### SUMMARY OF THE INVENTION

The present invention is generally directed to a method, system and article of manufacture for providing natural language support in a database environment and, more particularly, for providing natural language support for users running queries in an abstract database environment.

One embodiment provides a computer-implemented method of providing language transformation support for a query result obtained in response to execution of a query against an underlying database containing physical data. The method comprises identifying one or more physical values defined by the physical data for the query result for the executed query. Then, a user-defined function configured to transform the one or more identified physical values from a first language defined by the physical data in the underlying database into alternative values defined in a second language is retrieved. The method further comprises outputting the query result in the second language on the basis of the user-defined function.

Another embodiment provides a computer-readable medium containing a program which, when executed by a processor, performs a process of providing natural language support for users running queries against a database. The process comprises receiving, from a user, an abstract query comprising a plurality of logical fields defined by a data abstraction model abstractly describing physical data in the database. From the plurality of logical fields, at least one logical field having one or more allowed physical values defined by the physical data in the database is identified. Then, a first language resource component configured to transform the one or more allowed physical values into alternative values defined in a first natural language is retrieved. The process further comprises transforming the abstract query into an executable query capable of being executed against the database. As a result of executing the executable query against the database, a result set including at least one portion of the one or more allowed physical values is obtained. The result set is output in the first natural language on the basis of the first language resource component.

Another embodiment provides a computer-readable medium containing a program which, when executed by a processor, performs a process of providing natural language support for users processing query results. The process comprises retrieving a query result including one or more user-friendly values defined in a first natural language. The one or more user-friendly values are transformed into corresponding physical values consistent with physical data in an underlying database. The process further comprises outputting the query result including only the corresponding physical values.

Yet another embodiment provides a computer-readable medium containing a program which, when executed by a processor, performs a process of providing language transformation support for a query result obtained in response to execution of a query against an underlying database containing physical data. The process comprises identifying one or more physical values defined by the physical data for the query result for the executed query. Then, a user-defined function configured to transform the one or more identified physical values from a first language defined by the physical data in the underlying database into alternative values defined in a second language is retrieved. The process further comprises outputting the query result in the second language on the basis of the user-defined function.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system illustratively utilized in accordance with the invention;

FIG. 2 is a relational view of software components in one embodiment;

FIGS. 3-4 are relational views of software components for abstract query management in one embodiment;

FIGS. 5-6 are flow charts illustrating the operation of a runtime component in one embodiment;

FIG. 7 is a relational view of software components in one embodiment;

FIGS. 8-10 are flow charts illustrating a method of providing natural language support in a database environment in one embodiment;

FIG. 11 is a flow chart illustrating a method of providing natural language support for users running queries against a database in one embodiment;

FIGS. 12-13 are screenshots illustrating natural language support for users running queries against a database in one embodiment;

FIG. 14 is a flow chart illustrating a method of generating user-defined functions for natural language support in one embodiment;

FIG. 15 is a flow chart illustrating a method of providing natural language support for query processing in one embodiment;

FIG. 16 is a screenshot illustrating an exemplary natural language query result according to one embodiment; and

FIG. 17 is a flow chart illustrating a method of providing natural language support in query result processing in one embodiment.

### DETAILED DESCRIPTION OF THE PREFERRED EMBODIMENTS

Introduction

The present invention is generally directed to a method, system and article of manufacture for providing natural language support in a database environment and, more particularly, for providing natural language support for users running abstract queries against a database. In the context of the invention, an abstract query is specified using one or more logical fields defined by a data abstraction model abstractly describing physical data in an underlying database.

In one embodiment, one or more allowed physical values are defined for at least one logical field of a given abstract query on the basis of physical data in an underlying database. The at least one logical field is associated with a language resource component configured to transform the one or more allowed physical values into alternative values defined in a given natural language (i.e., a language written by, and readable by, human-beings). According to one aspect, the language resource component is implemented as a user-defined function including suitable translation information.

For execution, the abstract query is transformed into an executable query capable of being executed against the underlying database on the basis of an underlying data abstraction model. Thereby, a contribution defined for the at least one logical field in the executable query is identified from the executable query. The identified contribution is associated, in the executable query, with the language resource component and the executable query is then executed against the underlying database.

As a result of executing the executable query against the underlying database, a result set including at least one portion of the one or more allowed physical values is obtained. The result set is output in the given natural language on the basis of the language resource component.

### Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

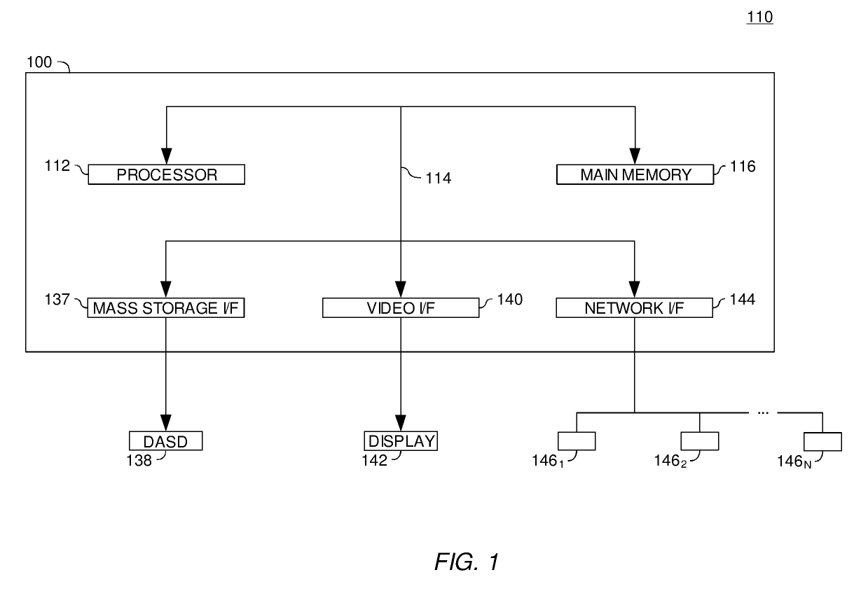

One embodiment of the invention is implemented as a program product for use with a computer system such as, for example, computer system 110 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD- or DVD-ROM disks readable by a CD- or DVD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

An Exemplary Computing Environment

FIG. 1 shows a computer 100 (which is part of a computer system 110) that becomes a special-purpose computer according to an embodiment of the invention when configured with the features and functionality described herein. The computer 100 may represent any type of computer, computer system or other programmable electronic device, including a client computer, a server computer, a portable computer, a personal digital assistant (PDA), an embedded controller, a PC-based server, a minicomputer, a midrange computer, a mainframe computer, and other computers adapted to support the methods, apparatus, and article of manufacture of the invention.

Illustratively, the computer 100 is part of a networked system 110. In this regard, the invention may be practiced in a distributed computing environment in which tasks are performed by remote processing devices that are linked through a communications network. In a distributed computing environment, program modules may be located in both local and remote memory storage devices. In another embodiment, the computer 100 is a standalone device. For purposes of construing the claims, the term “computer” shall mean any computerized device having at least one processor. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention can apply to any comparable configuration, regardless of whether the computer 100 is a complicated multi-user apparatus, a single-user workstation, or a network appliance that does not have non-volatile storage of its own.

The computer 100 could include a number of operators and peripheral systems as shown, for example, by a mass storage interface 137 operably connected to a storage device 138, by a video interface 140 operably connected to a display 142, and by a network interface 144 operably connected to the plurality of networked devices 146 (which may be representative of the Internet) via a suitable network. Although storage 138 is shown as a single unit, it could be any combination of fixed and/or removable storage devices, such as fixed disc drives, floppy disc drives, tape drives, removable memory cards, or optical storage. The display 142 may be any video output device for outputting viewable information.

Computer 100 is shown comprising at least one processor 112, which obtains instructions and data via a bus 114 from a main memory 116. The processor 112 could be any processor adapted to support the methods of the invention. In particular, the computer processor 112 is selected to support the features of the present invention. Illustratively, the processor is a PowerPC® processor available from International Business Machines Corporation of Armonk, N.Y.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in the computer system 110, for example, any storage capacity used as virtual memory or stored on a mass storage device (e.g., direct access storage device 138) or on another computer coupled to the computer 100 via bus 114. Thus, main memory 116 and storage device 138 could be part of one virtual address space spanning multiple primary and secondary storage devices.

An Exemplary Database and Query Environment

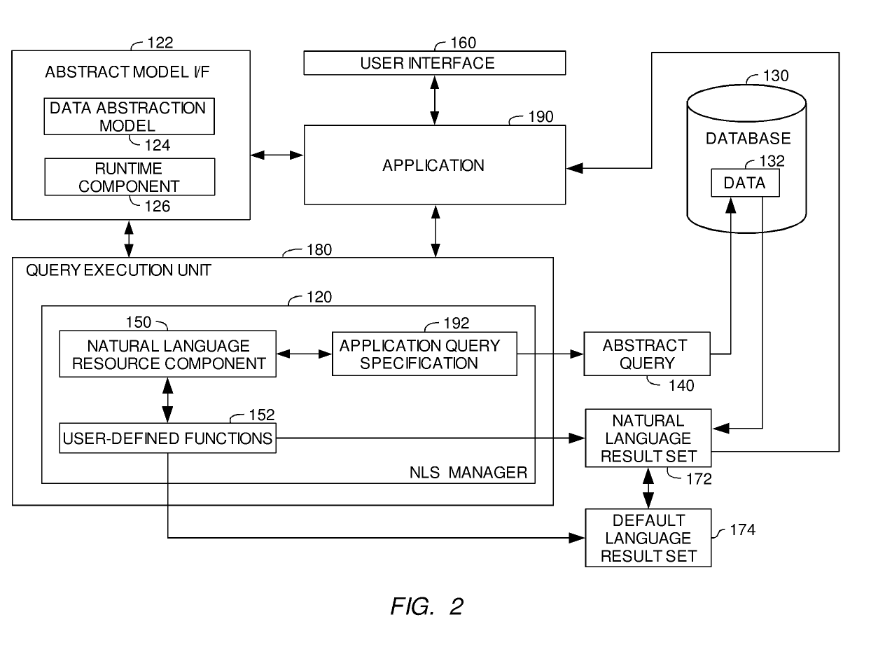

FIG. 2 illustrates a relational view of software components, according to one embodiment of the invention. The software components include a database 130, an abstract model interface 122, a user interface 160, a query execution unit 180 and one or more applications 190 (only one application is illustrated for simplicity).

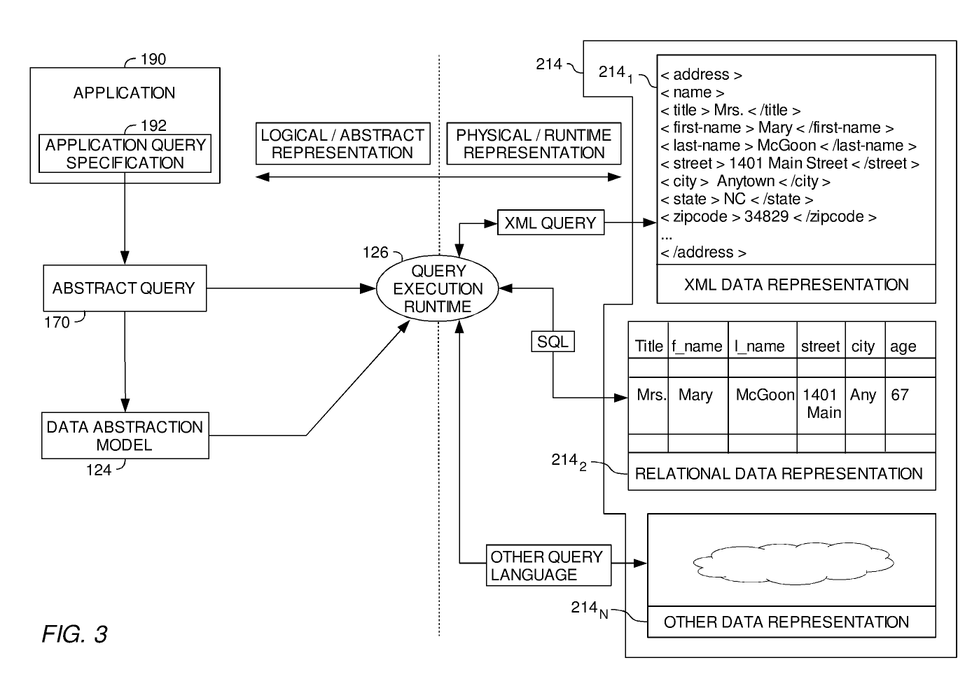

According to one aspect, the application 190 (and more generally, any requesting entity including, at the highest level, users) issues queries, such as abstract query 170, against data 132 in the database 130. The queries issued by the application 190 are defined according to an application query specification 192. The application query specification(s) 192 and the abstract model interface 122 are further described below with reference to FIGS. 3-6.

The queries issued by the application 190 may be predefined (i.e., hard coded as part of the application 190) or may be generated in response to input (e.g., user input). In one embodiment, the queries issued by the application 190 are created by users using the user interface 160, which can be any suitable user interface configured to create/submit queries. According to one aspect, the user interface 160 is a graphical user interface. However, it should be noted that the user interface 160 is only shown by way of example; any suitable requesting entity may create and submit queries against the database 130 (e.g., the application 190, an operating system or an end user). Accordingly, all such implementations are broadly contemplated.

In one embodiment, the requesting entity accesses a suitable database connectivity tool such as a Web application, an Open DataBase Connectivity (ODBC) driver, a Java DataBase Connectivity (JDBC) driver or a Java Application Programming Interface (Java API) for creation of a query. A Web application is an application that is accessible by a Web browser and that provides some function beyond static display of information, for instance by allowing the requesting entity to query the database 130. An ODBC driver is a driver that provides a set of standard application programming interfaces to perform database functions such as connecting to the database 130, performing dynamic SQL functions, and committing or rolling back database transactions. A JDBC driver is a program included with a database management system to support JDBC standard access between the database 130 and Java applications. A Java API is a Java-based interface that allows an application program (e.g., the requesting entity, the ODBC or the JDBC) that is written in a high-level language to use specific data or functions of an operating system or another program (e.g., the application 190).

Accordingly, the queries issued by the application 190 can be in physical form, such as SQL and/or XML queries, which are consistent with the physical representation of the data 132 in the database 130. Alternatively, the queries issued by the application 190 are composed using the abstract model interface 122. Such queries are referred to herein as “abstract queries”. More specifically, abstract queries are created on the basis of logical fields defined by a data abstraction model 124. The abstract queries are transformed into a form consistent with the physical representation of the data 132 for execution. For instance, the abstract queries are transformed by a runtime component 126 into concrete (i.e., executable) queries which are executed by the query execution unit 180 against the data 132 of the database 130.

The database 130 is representative of any collection of data regardless of the particular physical representation. By way of illustration, the database 130 may be organized according to a relational schema (accessible by SQL queries) or according to an XML schema (accessible by XML queries). However, the invention is not limited to a particular schema and contemplates extensions to schemas presently unknown. As used herein, the term “schema” generically refers to a particular arrangement of data.

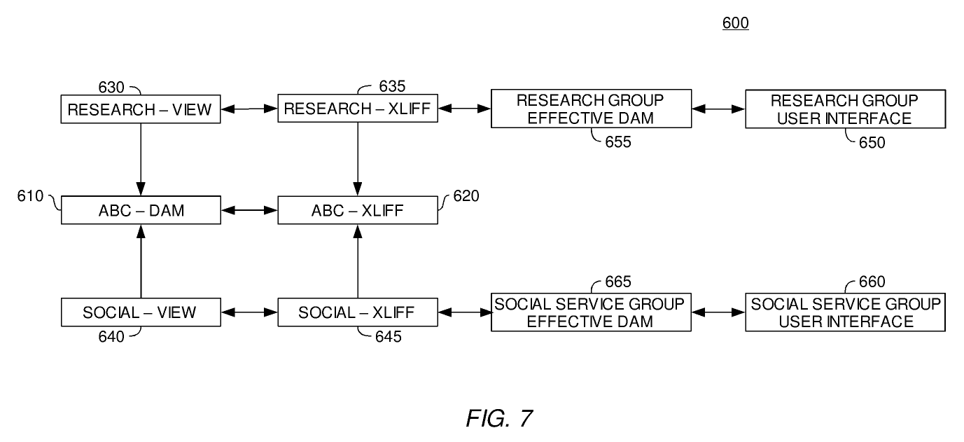

Illustratively, the query execution unit 180 includes a natural language support (NLS) manager 120. The NLS manager 120 provides natural language support for users running queries against the database 130. Interaction and operation of the NLS manager 120, the application 190 and the abstract model interface 122 to provide natural language support in query execution is explained in more detail below with reference to FIGS. 7-17.

Illustratively, the NLS manager 120 includes a natural language resource component 150 (hereinafter referred to as language resource component 150), the application query specification 192 and one or more user-defined functions (UDFs) 152. The UDFs 152 define alternative values for allowed values of one or more logical fields of the data abstraction model 124, as described in more detail below. The language resource component 150 defines a natural language expression for user-viewable elements defined by logical fields of the data abstraction model 124. In one embodiment, the language resource component 150 implements the UDFs 152.

In one embodiment, the language resource component 150 defines a natural language expression for each attribute (e.g., name) and/or corresponding value in a logical field. These natural language expressions can be different from expressions defined by the data abstraction model 124 (hereinafter referred to as “default language expressions”). Accordingly, the language resource component 150 is considered to provide translation information for the data abstraction model 124.

More generally, the language resource component 150 includes translations for one or more of the elements (e.g., logical field names, values, etc.) defined by the data abstraction model 124 from a first natural language expression (e.g., the default language expressions) to a second natural language expression (e.g., expressions in a foreign language). For a given data abstraction model 124, the language resource component 150 can further be configured to describe translations from the first natural language expression into two or more other natural language expressions. Thus, in one embodiment, which instance of the data abstraction model 124 a user “sees” will depend upon which natural language expression files are loaded to define the language resource component 150. In any case, the various natural language expressions can be different languages or different variations on the same language.

It is noted that particular embodiments described herein can refer to translation of selected elements of the data abstraction model 124. For example, embodiments may be described with reference to field name translations (e.g., “gender” translated to “sex”). However, references to translations of specific data abstraction model elements are done merely for purposes of illustration and not limiting of the invention. Thus, it is broadly contemplated that any element of the data abstraction model 124 can be translated.

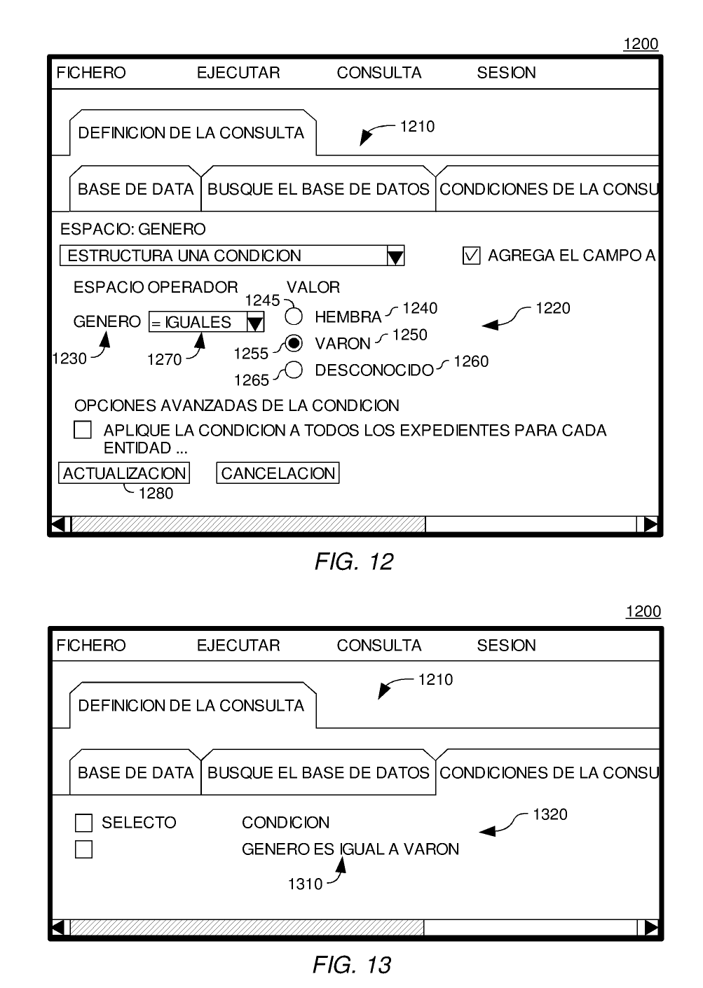

In one embodiment, the language resource component 150 is used for natural language support of users running an abstract query, such as the abstract query 170, against the data 132 of the database 130. To this end, the language resource component 150 defines one or more natural language expressions for each of a plurality of logical fields of the data abstraction model 124 which provides definitions (also referred to herein as “specifications”) for the plurality of logical fields. More specifically, the language resource component 150 can be used to determine natural language expression(s) for elements of logical fields displayed to the user for creation of the abstract query 170. Thus, the elements of the logical fields that are available for specification of the abstract query 170 can be displayed to the user in the determined natural language expression(s). Accordingly, the user can compose the abstract query 170 using the one or more elements of the logical fields in the displayed natural language expression(s). Query creation using natural language expressions is illustrated in FIGS. 12-13 which show exemplary screenshots illustrating display of elements of logical fields using exemplary Spanish expressions.

As was noted above, the abstract query 170 is transformed by a runtime component 126 into an executable query which is executed by the query execution unit 180 against the data 132 of the database 130. It should be noted that the query execution unit 180 illustratively only includes the NLS manager 120, for simplicity. However, the query execution unit 180 may include other components, such as a query engine, a query parser and a query optimizer. A query parser is generally configured to accept a received executable query input from a requesting entity, such as the application(s) 190, and then parse the received executable query. The query parser may then forward the parsed executable query to the query optimizer for optimization. A query optimizer is an application program which is configured to construct a near optimal search strategy (known as an “access plan”) for a given set of search parameters, according to known characteristics of an underlying database (e.g., the database 130), an underlying system on which the search strategy will be executed (e.g., computer system 110 of FIG. 1), and/or optional user specified optimization goals. But not all strategies are equal and various factors may affect the choice of an optimum search strategy. However, in general such search strategies merely determine an optimized use of available hardware/software components to execute respective queries. Once an access plan is selected, the query engine may then execute the executable query according to the selected access plan.

When executing the executable query against the database 130, the query execution unit 180 determines a default language result set 174 from the database 130. The default language result set 174 is a query result that includes physical data of the database 130 that is defined in a default language using default language expressions defined by the data abstraction model 124. In one embodiment, the default language result set 174 is transformed by the NLS manager 120 into a natural language result set 172 for output to the application 190. The transformation of the default language result set 174 into the natural language result set 172 is performed using the UDFs 152.

In one embodiment, the UDFs 152 define alternative values for allowed physical values of logical fields of the data abstraction model 124. The allowed physical values correspond to physical values included with the data 132 in the database 130. The physical values are defined in a base language using base language expressions, which can be encoded as described in more detail below by way of example. The alternative values are defined in a given natural language using natural language expressions which are considered to be more meaningful to users and, thus, more user-friendly. In one embodiment, the alternative values can be adapted to a role of a given user or a preferred language used by the user.

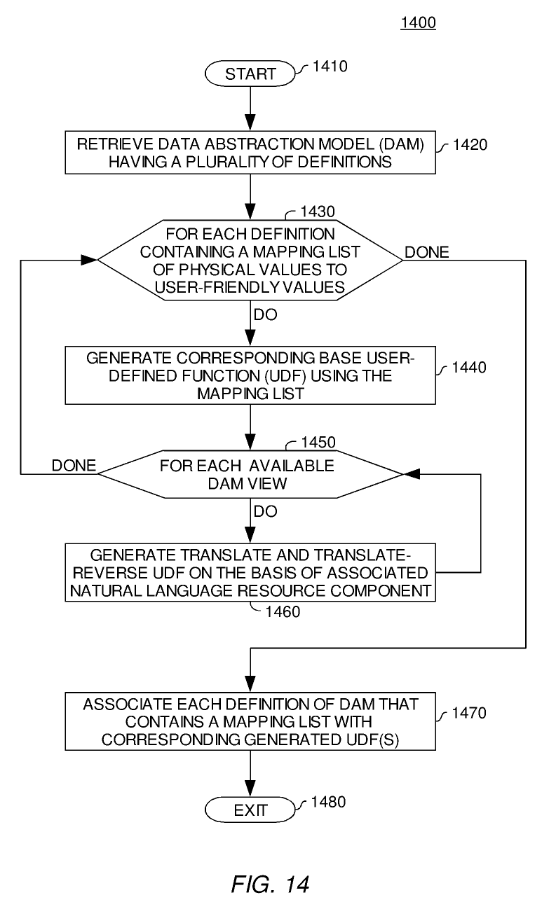

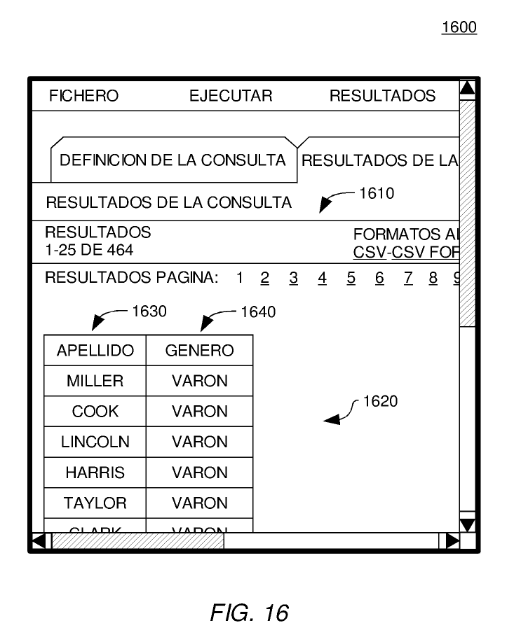

For instance, assume a logical field related to the “Gender” of patients in a hospital. Assume further that allowed physical values for the “Gender” field in the base language are “F”, “M”, and “U”. However, as “F”, “M” and “U” may not be meaningful to all users, translation of these physical values from the base language to a desired natural language can be required. By way of example, translation of these allowed physical values into user-friendly English terms can be required. Accordingly, a given UDF can map “F” to “Female”, “M” to “Male” and “U” to “Unknown”. Assume now that the data abstraction model 124 is configured for use by users in the United States. Accordingly, the English expressions define the default language expressions included with the data abstraction model 124 and used for generation of the default language result set 174. Furthermore, translation of the allowed physical values into user-friendly Spanish terms can be required. In this case, another UDF can map “F” to “Hembra”, “M” to “Varón” and “U” to “Desconocido”. Thus, each allowed physical value for the “Gender” field which occurs in the result set 174 can be translated from the base language into the desired natural language using the appropriate UDF. In other words, if the user is a Spanish user, the UDF having the Spanish terms can be used for providing the natural language result set 172 in the Spanish language to the user. Accordingly, the natural language result set 172 can be generated and output to the application 190, thereby facilitating the understanding of the result set to the user. An exemplary natural language result set is illustrated in FIG. 16. Creation and use of suitable UDFs is described below with reference to FIGS. 14-17.

In one embodiment, the default language result set 174 is discarded prior to outputting the natural language result set 172 to the application 190. Alternatively, instead of including the default language expressions with the default language result set 174, they can automatically be translated into corresponding natural language expressions at runtime which are then included with the natural language result set 172, so that creation of the default language result set 174 can be omitted.

However, assume now that the user decides to store the outputted natural language result set 172 persistently for subsequent processing. In order to make the stored result set available for use by other users, the natural language result set 172 is automatically transformed into a base language result set in the base language prior to storing. In other words, in one embodiment the natural language result set 172 is never stored as such, but instead is transformed into the default language result set, which itself is stored. Thus, when the Spanish user accesses the stored base language result set, it can be translated again into the Spanish language as described above. However, when another user such as a German user retrieves the persistently stored base language result set for processing, it can be translated into German using appropriate UDFs as described above.

Logical/Runtime View of Environment

Referring now to FIG. 3, a relational view illustrating operation and interaction of the application(s) 190 and the data abstract model interface 122 of FIG. 2 is shown. The abstract model interface 122 illustratively provides an interface to the data abstraction model 124 and the runtime component 126 of FIG. 2.

The data abstraction model 124 defines logical fields corresponding to physical entities of data in a database 214 (e.g., database 130 of FIG. 2), thereby providing a logical representation of the data. In a relational database environment having a multiplicity of database tables, a specific logical representation having specific logical fields can be provided for each database table. In this case, all specific logical representations together constitute the data abstraction model 124. The physical entities of the data are arranged in the database 214 according to a physical representation of the data. By way of illustration, two physical representations are shown, an XML data representation 214₁ and a relational data representation 214₂. However, the physical representation 214_{N} indicates that any other physical representation, known or unknown, is contemplated.

In one embodiment, a different single data abstraction model is provided for each separate physical representation 214_{1, 2, . . . , N}, as explained above for the case of a relational database environment. In an alternative embodiment, a single data abstraction model 124 contains field specifications (with associated access methods) for two or more physical representations 214_{1, 2, . . . , N}.

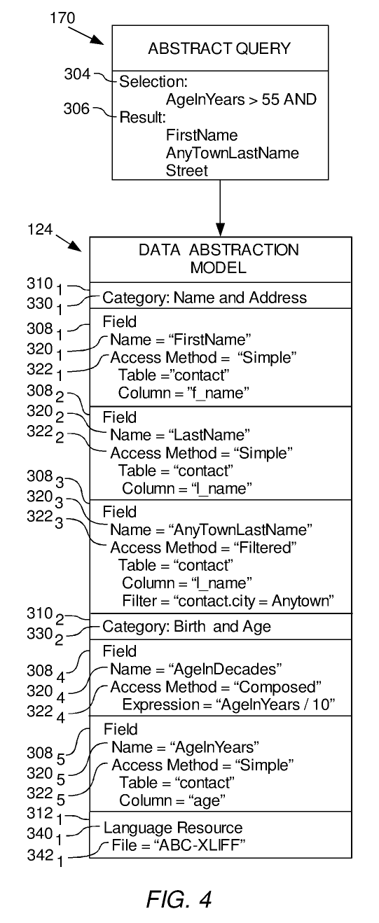

Using a logical representation of the data, the application query specification 192 of FIG. 2 specifies one or more logical fields to compose the abstract query 170 of FIG. 2. A requesting entity (e.g., the application 190) issues the abstract query 170 as defined by the application query specification 192. In one embodiment, the abstract query 170 may include both criteria used for data selection and an explicit specification of result fields to be returned based on the data selection criteria. An example of the selection criteria and the result field specification of the abstract query 170 is shown in FIG. 4. Accordingly, the abstract query 170 illustratively includes selection criteria 304 and a result field specification 306.

The abstract query 170 is generally referred to herein as an “abstract query” because the query is composed according to abstract (i.e., logical) fields rather than by direct reference to the underlying physical data entities in the database 214. As a result, abstract queries may be defined that are independent of the particular underlying physical data representation used. For execution, the abstract query 170 is transformed into a concrete query consistent with the underlying physical representation of the data using the data abstraction model 124.

In general, the data abstraction model 124 exposes information as a set of logical fields that may be used within an abstract query to specify criteria for data selection and specify the form of result data returned from a query operation. The logical fields are defined independently of the underlying physical representation being used in the database 214, thereby allowing abstract queries to be formed that are loosely coupled to the underlying physical representation.

Referring now to FIG. 4, a relational view illustrating interaction of the abstract query 170 and the data abstraction model 124 is shown. In one embodiment, the data abstraction model 124 comprises a plurality of field specifications 308₁, 308₂, 308₃, 308₄ and 308₅ (five shown by way of example), collectively referred to as the field specifications 308. Specifically, a field specification is provided for each logical field available for composition of an abstract query. Each field specification may contain one or more attributes. Illustratively, the field specifications 308 include a logical field name attribute 320₁, 320₂, 320₃, 320₄, 320₅ (collectively, field names 320) and an associated access method attribute 322₁, 322₂, 322₃, 322₄, 322₅ (collectively, access methods 322). Each attribute may have a value. For example, logical field name attribute 320₁ has the value “FirstName” and access method attribute 322₁ has the value “Simple”. Furthermore, each attribute may include one or more associated abstract properties. Each abstract property describes a characteristic of a data structure and has an associated value. In the context of the invention, a data structure refers to a part of the underlying physical representation that is defined by one or more physical entities of the data corresponding to the logical fields. In particular, an abstract property may represent data location metadata abstractly describing a location of a physical data entity corresponding to the data structure, like a name of a database table or a name of a column in a database table. Illustratively, the access method attribute 322₁ includes data location metadata “Table” and “Column”. Furthermore, data location metadata “Table” has the value “contact” and data location metadata “Column” has the value “f_name”. Accordingly, assuming an underlying relational database schema in the present example, the values of data location metadata “Table” and “Column” point to a table “contact” having a column “f_name”.

In one embodiment, groups (i.e. two or more) of logical fields may be part of categories. Accordingly, the data abstraction model 124 includes a plurality of category specifications 310₁ and 310₂ (two shown by way of example), collectively referred to as the category specifications. In one embodiment, a category specification is provided for each logical grouping of two or more logical fields. For example, logical fields 308₁₋₃ and 308₄₋₅ are part of the category specifications 310₁ and 310₂, respectively. A category specification is also referred to herein simply as a “category”. The categories are distinguished according to a category name, e.g., category names 330₁ and 330₂ (collectively, category name(s) 330). In the present illustration, the logical fields 308₁₋₃ are part of the “Name and Address” category and logical fields 308₄₋₅ are part of the “Birth and Age” category.

The access methods 322 generally associate (i.e., map) the logical field names to data in the database (e.g., database 214). Any number of access methods is contemplated depending upon the number of different types of logical fields to be supported. In one embodiment, access methods for simple fields, filtered fields and composed fields are provided. The field specifications 308₁, 308₂ and 308₅ exemplify simple field access methods 322₁, 322₂, and 322₅, respectively. Simple fields are mapped directly to a particular entity in the underlying physical representation (e.g., a field mapped to a given database table and column). By way of illustration, as described above, the simple field access method 322₁ shown in FIG. 4 maps the logical field name 320₁ (“FirstName”) to a column named “f_name” in a table named “contact”. The field specification 308₃ exemplifies a filtered field access method 322₃. Filtered fields identify an associated physical entity and provide filters used to define a particular subset of items within the physical representation. An example is provided in FIG. 4 in which the filtered field access method 322₃ maps the logical field name 320₃ (“AnyTownLastName”) to a physical entity in a column named “I_name” in a table named “contact” and defines a filter for individuals in the city of “Anytown”. Another example of a filtered field is a New York ZIP code field that maps to the physical representation of ZIP codes and restricts the data only to those ZIP codes defined for the state of New York. The field specification 308₄ exemplifies a composed field access method 322₄. Composed access methods compute a logical field from one or more physical fields using an expression supplied as part of the access method definition. In this way, information which does not exist in the underlying physical data representation may be computed. In the example illustrated in FIG. 4 the composed field access method 322₄ maps the logical field name 320₄ “AgeInDecades” to “AgeInYears/10”. Another example is a sales tax field that is composed by multiplying a sales price field by a sales tax rate.

It is contemplated that the formats for any given data type (e.g., dates, decimal numbers, etc.) of the underlying data may vary. Accordingly, in one embodiment, the field specifications 308 include a type attribute which reflects the format of the underlying data. However, in another embodiment, the data format of the field specifications 308 is different from the associated underlying physical data, in which case a conversion of the underlying physical data into the format of the logical field is required.

By way of example, the field specifications 308 of the data abstraction model 124 shown in FIG. 4 are representative of logical fields mapped to data represented in the relational data representation 214₂ shown in FIG. 3. However, other instances of the data abstraction model 124 map logical fields to other physical representations, such as XML.

An illustrative abstract query corresponding to the abstract query 170 shown in FIG. 4 is shown in Table I below. By way of illustration, the illustrative abstract query is defined using XML. However, any other language may be used to advantage.

TABLE I
ABSTRACT QUERY EXAMPLE

| | |
|---|---|
| 001 | <?xml version=“1.0”?> |
| 002 | <!--Query string representation: (AgeInYears > “55”--> |
| 003 | <QueryAbstraction> |
| 004 | <Selection> |
| 005 | <Condition internalID=“4”> |
| 006 | <Condition field=“AgeInYears” operator=“GT” |
| 007 | value=“55” internalID=“1”/> |
| 008 | </Selection> |
| 009 | <Results> |
| 010 | <Field name=“FirstName”/> |
| 011 | <Field name=“AnyTownLastName”/> |
| 012 | <Field name=“Street”/> |
| 013 | </Results> |
| 014 | </QueryAbstraction> |

Illustratively, the abstract query shown in Table I includes a selection specification (lines 004-008) containing selection criteria and a results specification (lines 009-013). In one embodiment, a selection criterion consists of a field name (for a logical field), a comparison operator (=, >, <, etc) and a value expression (what is the field being compared to). In one embodiment, result specification is a list of abstract fields that are to be returned as a result of query execution. A result specification in the abstract query may consist of a field name and sort criteria.

In one embodiment, the abstract query shown in Table I is constructed by an application (e.g., application 190 of FIG. 2). Furthermore, a language resource component (e.g., language resource component 150 of FIG. 2) is provided which is associated with the data abstraction model 124. The language resource component can be adapted, for instance, to translate elements (e.g., logical field names, values, etc.) of the data abstraction model 124 into the Russian language. Thus, the application may construct the abstract query using the translation of each element in the Russian language. An associated NLS manager (e.g., NLS manager 120 of FIG. 2) can generate an internal representation of the abstract query in a default or untranslated form, i.e., without using the Russian language translations. Thus, the internal representation can be used and accessed by the runtime component 126 for processing.

In one embodiment, the language resource component associated with the data abstraction model 124 (or at least a file defining a portion of the language resource component) is specified within the data abstraction model 124 itself. Accordingly, the data abstraction model 124 shown in FIG. 4 includes a resource specification 312₁. The language resource specification 312₁ includes a reference to a particular language resource component (e.g., language resource component 150 of FIG. 2, or a portion thereof) which is associated with the data abstraction model 124. Illustratively, the language resource specification 312₁ includes a language resource file definition 340₁ having an abstract attribute 342₁ “File”. By way of example, the language resource file definition 340₁ indicates a corresponding language resource file name “ABC-XLIFF”. Additional aspects of an illustrative “ABC-XLIFF” language resource file are described below.

An illustrative Data Abstraction Model (DAM) corresponding to the data abstraction model 124 shown in FIG. 4 is shown in Table II below. By way of illustration, the illustrative data abstraction model is defined using XML. However, any other language may be used to advantage.

TABLE II
DATA ABSTRACTION MODEL EXAMPLE

| | |
|---|---|
| 001 | <?xml version=“1.0”?> |
| 002 | <DataAbstraction> |
| 003 | <Category name=“Name and Address”> |
| 004 | <Field queryable=“Yes” name=“FirstName” displayable=“Yes”> |
| 005 | <AccessMethod> |
| 006 | <Simple columnName=“f_name” tableName=“contact”></Simple> |
| 007 | </AccessMethod> |
| 008 | </Field> |
| 009 | <Field queryable=“Yes” name=“LastName” displayable=“Yes”> |
| 010 | <AccessMethod> |
| 011 | <Simple columnName=“l_name” tableName=“contact”></Simple> |
| 012 | </AccessMethod> |
| 013 | </Field> |
| 014 | <Field queryable=“Yes” name=“AnyTownLastName” displayable=“Yes”> |
| 015 | <AccessMethod> |
| 016 | <Filter columnName=“l_name” tableName=“contact” |
| 017 | Filter=”contact.city=Anytown”></Filter> |
| 018 | </AccessMethod> |
| 019 | </Field> |
| 020 | </Category> |
| 021 | <Category name=“Birth and Age”> |
| 022 | <Field queryable=“Yes” name=“AgeInDecades” displayable=“Yes”> |
| 023 | <AccessMethod> |
| 024 | <Composed columnName=“age” tableName=“contact” |
| 025 | Expression=”columnName/10”></Composed> |
| 026 | </AccessMethod> |
| 027 | </Field> |
| 028 | <Field queryable=“Yes” name=“AgeInYears” displayable=“Yes”> |
| 029 | <AccessMethod> |
| 030 | <Simple columnName=“age” tableName=“contact”></Simple> |
| 031 | </AccessMethod> |
| 032 | </Field> |
| 033 | </Category> |
| 034 | <LanguageResource file=“ABC-XLIFF.xml”> |
| 035 | </DataAbstraction> |

By way of example, note that lines 004-008 correspond to the first field specification 308₁ of the DAM 124 shown in FIG. 4 and lines 009-013 correspond to the second field specification 308₂. The other field specifications of FIG. 4 are shown in headlines 014-019, 022-027, and 028-032. Furthermore, note that line 034 corresponds to the language resource file definition 340₁ of the DAM shown in FIG. 4. More specifically, line 034 includes a reference to an exemplary “ABC-XLIFF.xml” language resource file. In one embodiment, the ABC-XLIFF.xml file defines a default file containing default natural language expressions for a plurality of elements of the data abstraction model 124. One or more additional language resource files may then be loaded and applied to the default file to define a particular view of the data abstraction model 124. Determination of an appropriate language resource file and loading of one or more language resource files associated with a data abstraction model can be performed using conventional techniques applied to the data abstraction model. Examples of determination and loading are explained in more detail below with reference to FIGS. 7-10.

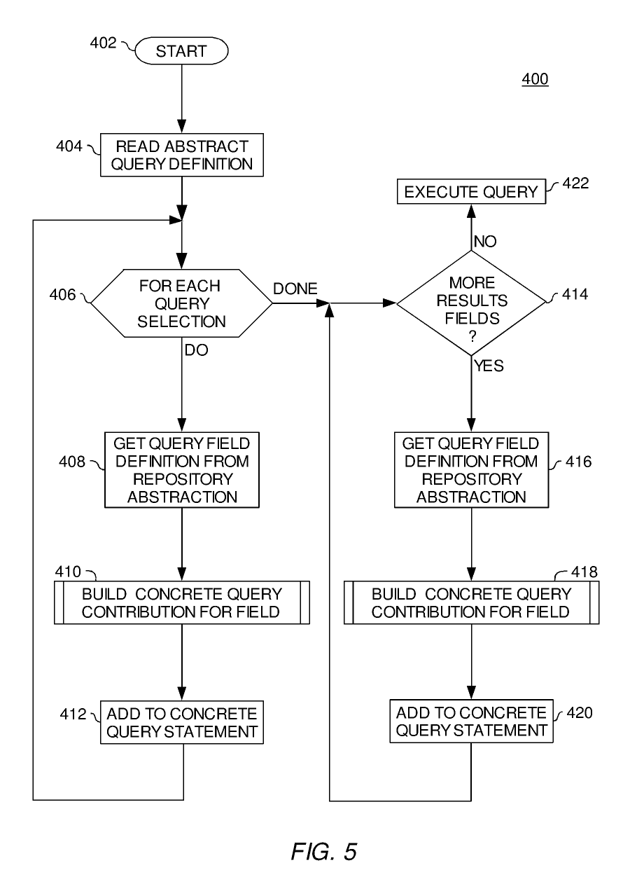

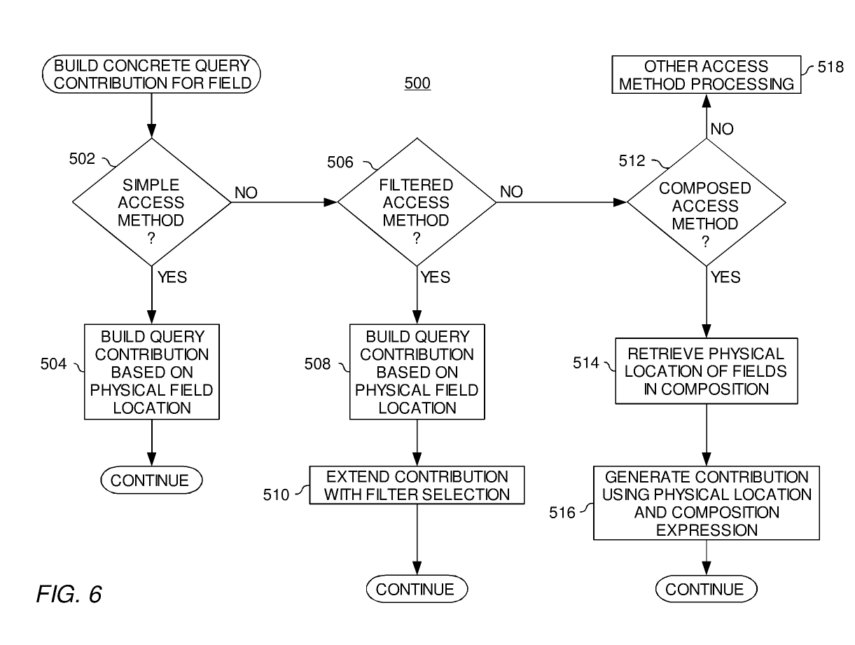

As was noted above, the abstract query of Table I can be transformed into a concrete query for query execution. An exemplary method for transforming an abstract query into a concrete query is described below with reference to FIGS. 5-6.

Transforming an Abstract Query into a Concrete Query

Referring now to FIG. 5, an illustrative runtime method 400 exemplifying one embodiment of the operation of the runtime component 126 of FIGS. 2-3 in conjunction with the data abstraction model 124 of FIGS. 2-3 is shown. The method 400 is entered at step 402 when the runtime component 126 receives as input an abstract query (such as the abstract query shown in Table I). At step 404, the runtime component 126 reads and parses the abstract query and locates individual selection criteria and desired result fields. At step 406, the runtime component 126 enters a loop (comprising steps 406, 408, 410 and 412) for processing each query selection criteria statement present in the abstract query, thereby building a data selection portion of a concrete query. In one embodiment, a selection criterion consists of a field name (for a logical field), a comparison operator (=, >, <, etc) and a value expression (what is the field being compared to). At step 408, the runtime component 126 uses the field name from a selection criterion of the abstract query to look up the definition of the field in the data abstraction model 124. As noted above, the field definition includes a definition of the access method used to access the physical data associated with the field. The runtime component 126 then builds (step 410) a concrete query contribution for the logical field being processed. As defined herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from the physical data repository, represented by the database 214 shown in FIG. 3. The concrete query contribution generated for the current field is then added to a concrete query statement. The method 400 then returns to step 406 to begin processing for the next field of the abstract query. Accordingly, the process entered at step 406 is iterated for each data selection field in the abstract query, thereby contributing additional content to the eventual query to be performed.

After building the data selection portion of the concrete query, the runtime component 126 identifies the information to be returned as a result of query execution. As described above, in one embodiment, the abstract query defines a list of abstract fields that are to be returned as a result of query execution, referred to herein as a result specification. A result specification in the abstract query may consist of a field name and sort criteria. Accordingly, the method 400 enters a loop at step 414 (defined by steps 414, 416, 418 and 420) to add result field definitions to the concrete query being generated. At step 416, the runtime component 126 looks up a result field name (from the result specification of the abstract query) in the data abstraction model 124 and then retrieves a result field definition from the data abstraction model 124 to identify the physical location of data to be returned for the current logical result field. The runtime component 126 then builds (at step 418) a concrete query contribution (of the concrete query that identifies physical location of data to be returned) for the logical result field. At step 420, the concrete query contribution is then added to the concrete query statement. Once each of the result specifications in the abstract query has been processed, the concrete query is executed at step 422.

One embodiment of a method 500 for building a concrete query contribution for a logical field according to steps 410 and 418 is described with reference to FIG. 6. At step 502, the method 500 queries whether the access method associated with the current logical field is a simple access method. If so, the concrete query contribution is built (step 504) based on physical data location information and processing then continues according to method 400 described above. Otherwise, processing continues to step 506 to query whether the access method associated with the current logical field is a filtered access method. If so, the concrete query contribution is built (step 508) based on physical data location information for some physical data entity. At step 510, the concrete query contribution is extended with additional logic (filter selection) used to subset data associated with the physical data entity. Processing then continues according to method 400 described above.

If the access method is not a filtered access method, processing proceeds from step 506 to step 512 where the method 500 queries whether the access method is a composed access method. If the access method is a composed access method, the physical data location for each sub-field reference in the composed field expression is located and retrieved at step 514. At step 516, the physical field location information of the composed field expression is substituted for the logical field references of the composed field expression, whereby the concrete query contribution is generated. Processing then continues according to method 400 described above.

If the access method is not a composed access method, processing proceeds from step 512 to step 518. Step 518 is representative of any other access methods types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used.

Natural Language Support in Creation of Abstract Queries

Referring now to FIG. 7, a relational view illustrating natural language support for a data abstraction model in accordance with an associated language resource component in one embodiment is shown. More specifically, FIG. 7 shows a data abstraction model “ABC-DAM” 610 (e.g., data abstraction model 124 of FIG. 2) and two different views of the data abstraction model 610. In general, a view of the data abstraction model 610 defines how the data abstraction model 610 is presented to a user. For example, the view may reflect group security settings for a specific group of users. Accordingly, using different views of the data abstraction model 610 according to group security settings, users can be authorized to access information in the data abstraction model 610 based on a corresponding security level assigned to their respective user group. For simplicity, only two views are shown, i.e., a “RESEARCH-VIEW” 630 and a “SOCIAL-VIEW” 640. By way of example, the “RESEARCH-VIEW” 630 defines a view of the data abstraction model 610 for users in a research group and the “SOCIAL-VIEW” 640 defines a view for users in a social service group.

Illustratively, the data abstraction model 610 is associated with a language resource component “ABC-XLIFF” 620. The views 630 and 640 are associated with language resource components “RESEARCH-XLIFF” 635 and “SOCIAL-XLIFF” 645, respectively. In one embodiment, the language resource components 620, 635 and 645 are XLIFF resources. XLIFF (XML Localization Interchange File Format) is an XML based open format designed to capture localizable information (i.e., resources) and to operate with translation tools. Accordingly, the language resource components 620, 635 and 645 can be implemented by XLIFF language resource files (referred to herein as language resource files).

In one embodiment, the language resource file 620 is a default language resource file that includes default natural language expressions for each logical field defined by the data abstraction model 610. In other words, the default language resource file includes all natural language expressions as defined in the data abstraction model 610. However, it should be noted that provision of the default language resource file is optional. Instead of using the default language resource file, all default natural language expressions can be determined directly from the data abstraction model 610. Accordingly, in one embodiment, the language resource file 620 includes natural language expressions which describe translations of each logical field of the data abstraction model 610 into another language or a variation on the same language.

The language resource files 635 and 645 include translations of increasing specificity to replace relatively less specific translations of the language resource file 620. Each of the language resource files 635 and 645 can be used in combination with the language resource file 620 to translate natural language expressions in the data abstraction model 610 according to the views 630 and 640, respectively. Thus, by applying the view 630 and the language resource file 635 (in combination with the language resource file 620) to the data abstraction model 610, an effective data abstraction model “RESEARCH GROUP EFFECTIVE DAM” 655 can be created for a research group user using the “RESEARCH-VIEW” 630. An effective data abstraction model is an in-memory representation of a default data abstraction model (e.g., “ABC-DAM” 610) as modified by applying a view thereto and/or by aggregating multiple data abstraction models into a single larger data abstraction model. The effective data abstraction model 655 can be displayed in a user interface 650. Thus, the user interface 650 is displayed in accordance with the natural language expressions defined by the language resource files 620 and 635. Accordingly, for a social service group user using the “SOCIAL-VIEW” 640, an effective data abstraction model “SOCIAL SERVICE GROUP EFFECTIVE DAM” 665 can be created and displayed in a user interface 660. Thus, the user interface 660 is displayed in accordance with the natural language expressions defined by the language resource files 620 and 645. The data abstraction model 610, the views 630 and 640, the associated language resource files 620, 635 and 645, the effective data abstraction models 655 and 665 and the user interfaces 650 and 660 are explained in more detail below with respect to Tables III-X.

As an example of the data abstraction model “ABC-DAM” 610, the exemplary data abstraction model “ABC-DAM.xml” shown in Table III below is illustrated. For simplicity, elements of the “ABC-DAM.xml” data abstraction model are represented in a shorthand format. Persons skilled in the art will readily recognize corresponding XML representations. Further, for brevity, only parts that are relevant for the following explanations are shown. It is noted that this manner of presentation applies to other tables described below as well.

TABLE III
DATA ABSTRACTION MODEL EXAMPLE

| | |
|---|---|
| 001 | ABC-DAM.xml |
| 002 | +---> Demographic: Patient demographic information |
| 003 | +--> Gender |
| 004 | +-->Value: actualVal = “F” -> val = ”Female” |
| 005 | +-->Value: actualVal = “M” -> val = ”Male” |
| 006 | +-->Value: actualVal =”U” -> val = “Unknown” |
| 007 | +--> Name |
| 008 | +--> SSN: This is the patient's social security number |
| 009 | +---> Diagnosis: Patient diagnostic information |
| 010 | +--> Disease |
| 011 | +--> Name |
| 012 | +---> Language Resource |
| 013 | +--> ABC-XLIFF.xml |

As can be seen from lines 002 and 009, the exemplary data abstraction model includes two categories, i.e., “Demographic” and “Diagnosis”. By way of example, the “Demographic” category includes definitions for a “Gender” (lines 003-006), “Name” (line 007) and “SSN” (line 008) logical field. Assume now that the “Gender” field refers to a “gender” column in a table of an underlying database (e.g., database 130 of FIG. 2). Furthermore, as can be seen from lines 004-006 of Table III, the definition of the “Gender” field includes a mapping list of allowed physical values to alternative user-friendly values in a default language, here English. More specifically, the allowed physical values for the “Gender” field are “F”, “M” and “U” and are defined in a base language. These allowed physical values correspond to physical values in the “gender” column and are defined as actual values (“actualVal”). These allowed values are respectively mapped to the default language expressions “Female”, “Male” and “Unknown” (“val” in lines 004-006 of Table III) in the English language. It should further be noted that the “Diagnosis” category also includes a “Name” field (line 011). Furthermore, as can be seen from line 013, the exemplary data abstraction model of Table III is associated with the language resource file “ABC-XLIFF.xml”. An exemplary language resource file exemplifying the language resource file “ABC-XLIFF” 620 is shown in Table IV below.

TABLE IV
ABC-XLIFF FILE EXAMPLE

| | |
|---|---|
| 001 | ABC-XLIFF.xml |
| 002 | “Demographic.Gender:name” = “Gender” |
| 003 | “Demographic.Gender:val-Female” = “Female” |
| 004 | “Demographic.Gender:val-Male” = “Male” |
| 005 | “Demographic.Gender:val-Unknown” = “Unknown” |
| 006 | “Demographic.Name:name” = “Name” |
| 007 | “Demographic.SSN:description” = “This is the patient's social |
| | security number” |
| 008 | “Demographic.SSN:name” = “SSN” |
| 009 | “Demographic:description” = “Patient demographic information” |
| 010 | “Demographic:name” = “Demographic” |
| 011 | “Diagnosis.Disease.Name:name” = “Name” |
| 012 | “Diagnosis.Disease:name” = “Disease” |
| 013 | “Diagnosis:description” = “Patient diagnostic information” |
| 014 | “Diagnosis:name” = “Diagnosis” |

The exemplary XLIFF language resource file of Table IV illustratively includes default natural language expressions for each attribute included in a logical field of the exemplary data abstraction model of Table III. More specifically, the exemplary XLIFF language resource file includes, on the left hand side of each line, a definition for an element (e.g., a logical field name or value) of the data abstraction model and, on the right hand side of each line, an associated value. In other words, the XLIFF language resource file of Table IV includes definition/value mappings for the data abstraction model of Table III. However, as already mentioned above, it should be noted that all information included in the exemplary default language resource file of Table IV is included in and can, thus, be retrieved from, the exemplary data abstraction model of Table III.

As an example of the “RESEARCH-VIEW” 630, an exemplary view of the data abstraction model of Table III for users of a research group is shown in Table V below. Further, for brevity, only parts that are relevant for the following explanations are shown.

TABLE V
RESEARCH-VIEW EXAMPLE

| | |
|---|---|
| 001 | RESEARCH-VIEW.xml |
| 002 | +---> Exclude |
| 003 | +--> Field: SSN |
| 004 | +---> Language Resource |
| 005 | +--> RESEARCH-XLIFF.xml |

By way of example, it is assumed that researchers should be prevented from seeing Social Security numbers (SSN) for security reasons. Accordingly, as can be seen from line 002, the view of Table V includes an “Exclude” attribute to exclude the logical field “SSN” (line 003) from the presentation of the data abstraction model 610 for display. In other words, the exemplary RESEARCH-VIEW is configured to implement group security settings for users of the RESEARCH group. Furthermore, as can be seen from line 005, the exemplary view of Table V is associated with the language resource file “RESEARCH-XLIFF.xml”. An exemplary language resource file exemplifying the language resource file “RESEARCH-XLIFF” 635 is shown in Table VI below.

TABLE VI
RESEARCH-XLIFF FILE EXAMPLE

| | |
|---|---|
| 001 | RESEARCH-XLIFF.xml |
| 002 | “Demographic.Name:name” = “Subject name” |
| 003 | “Demographic:description” = “Demographic” |
| 004 | “Diagnosis.Disease.Name:name” = “Syndrome name” |
| 005 | “Diagnosis:description” = “Diagnostic information” |

As can be seen from lines 002-005, natural language expressions for different definitions of the data abstraction model of Table III are provided, which replace corresponding natural language expressions of the language resource file of Table IV. In other words, it is assumed that researchers would prefer to view the data abstraction model of Table III according to a more technical terminology. Therefore, the natural language expressions shown in Table VI are intended to change the corresponding natural language expressions of Table IV according to a more technical terminology.

By applying the view of Table V and the language resource file of Table VI (in combination with the language resource file of Table IV) to the data abstraction model of Table III, an effective data abstraction model as illustrated in Table VII below can be generated for users of the research group and displayed in the user interface 650. The exemplary effective data abstraction model illustrated in Table VII is an example for the effective data abstraction model 655. For simplicity, only relevant displayed information is illustrated in Table VII.

TABLE VII
RESEARCH GROUP EFFECTIVE DAM EXAMPLE

| | |
|---|---|
| 001 | +---> Demographic: Demographic |
| 002 | +--> Gender |
| 003 | +-->Value: actualVal = “F” -> val = ”Female” |
| 004 | +-->Value: actualVal = “M” -> val = ”Male” |
| 005 | +-->Value: actualVal = “U” -> val = ”Unknown” |
| 006 | +--> Subject name |
| 007 | +---> Diagnosis: Diagnostic information |
| 008 | +--> Disease |
| 009 | +--> Syndrome name |

As can be seen from Table VII, the SSN information of the data abstraction model of Table III has been excluded from display. Furthermore, lines 001, 006, 007 and 009 are displayed according to the natural language expressions of the language resource file of Table VI.

As an example of the “SOCIAL-VIEW” 640, an exemplary view of the data abstraction model of Table III for users of a social service group is shown in Table VIII below. Further, for brevity, only parts that are relevant for the following explanations are shown.

TABLE VIII
SOCIAL-VIEW EXAMPLE

| | |
|---|---|
| 001 | SOCIAL-VIEW.xml |
| 002 | +---> IncludeAll |
| 003 | +---> Language Resource |
| 004 | +--> SOCIAL-XLIFF.xml |

By way of example, it is assumed that social service group users would need to access all information included in the “ABC-DAM” 610. Accordingly, as can be seen from line 002, the view of Table VIII includes an “IncludeAll” attribute to include all logical fields of the data abstraction model 610 for display. Furthermore, as can be seen from line 004, the exemplary view of Table VIII is associated with the language resource file “SOCIAL-XLIFF.xml”. An exemplary language resource file exemplifying the language resource file “SOCIAL-XLIFF” 645 is shown in Table IX below.

TABLE IX
SOCIAL-XLIFF FILE EXAMPLE

| | |
|---|---|
| 001 | SOCIAL-XLIFF.xml |
| 002 | “Demographic.Gender:val-Female” = “Girl” |
| 003 | “Demographic.Gender:val-Male” = “Boy” |
| 004 | “Demographic.Gender:val-Unknown” = “Unlisted” |
| 005 | “Demographic.Name:name” = “Patient name” |
| 006 | “Diagnosis.Disease.Name:name” = “Sickness name” |
| 007 | “Diagnosis:name” = “Likely Illness” |

As can be seen from lines 002-007, natural language expressions for different definitions of the data abstraction model of Table III are provided, which replace corresponding natural language expressions of the language resource file of Table IV. More specifically, it is assumed that social service group users would need to view the data abstraction model of Table III according to a less technical terminology. Therefore, the natural language expressions shown in Table IX are intended to change the corresponding natural language expressions of Table IV accordingly.

According to the view of Table VIII and the language resource file of Table IX (in combination with the language resource file of Table IV), the effective data abstraction model of Table X below can be generated for users of the social service group and displayed in the user interface 660. The exemplary data abstraction model of Table X is an example for the effective data abstraction model 665. For simplicity, only relevant displayed information is illustrated in Table X.

TABLE X
SOCIAL SERVICE GROUP EFFECTIVE DAM EXAMPLE

| | |
|---|---|
| 001 | +---> Demographic: Patient demographic information |
| 002 | +--> Gender |
| 003 | +-->Value: actualVal = “F” -> val = ”Girl” |
| 004 | +-->Value: actualVal = “M” -> val = ”Boy” |
| 005 | +-->Value: actualVal = “F” -> val = ”Unlisted” |
| 006 | +--> Patient name |
| 007 | +--> SSN: This is the patient's social security number |
| 008 | +---> Likely illness: Patient diagnostic information |
| 009 | +--> Disease |
| 010 | +--> Sickness name |

As can be seen from Table X, all information of the data abstraction model of Table III has been included for display. Furthermore, lines 003-006, 008 and 010 are displayed according to the natural language expressions of the language resource file of Table IX.

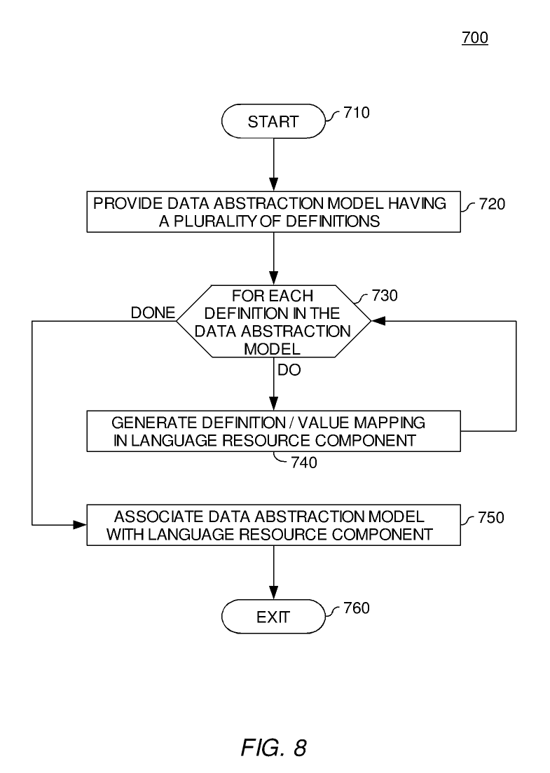

Referring now to FIG. 8, a method 700 for providing natural language support for users running queries (e.g., abstract query 170 of FIG. 2) against a database (e.g., database 130 of FIG. 2) is illustrated. In one embodiment, the method 700 is performed by the NLS manager 120 of FIG. 2. Method 700 starts at step 710.

At step 720, a data abstraction model (e.g., data abstraction model 610 of FIG. 7) including a plurality of logical fields abstractly describing physical data residing in the database is retrieved. Each logical field includes one or more attributes. For each attribute, a corresponding definition that uniquely identifies the attribute can be determined from the data abstraction model. At step 730, each definition in the data abstraction model is determined and, at step 740, a corresponding definition/value mapping is generated in a language resource component.

By way of example, for the attribute “Name” in line 007 of the exemplary “ABC-DAM” of Table III, a definition “Demographic.Name:name” is determined. For the attribute “Name” in line 011, a definition “Diagnosis.Disease.Name:name” is determined. Both definitions are mapped to the natural language expression or value “Name” according to lines 007 and 011 of the exemplary “ABC-DAM” of Table III. Furthermore, both definition/value mappings are generated in the exemplary “ABC-XLIFF” language resource file of Table IV (lines 006 and 011, respectively).

The method 700 performs a loop consisting of steps 730 and 740 until a corresponding definition/value mapping has been generated in the language resource component for each definition in the data abstraction model. Thus, the language resource component defines a natural language expression for each of the plurality of logical fields. Subsequently, method 700 proceeds with step 750.

At step 750, the data abstraction model is associated with the generated language resource component. For instance, a language resource file definition is included in the data abstraction model, e.g., language resource file definition “ABC-XLIFF.xml” in line 013 of the exemplary “ABC-DAM” of Table III. Method 700 then exits at step 760.

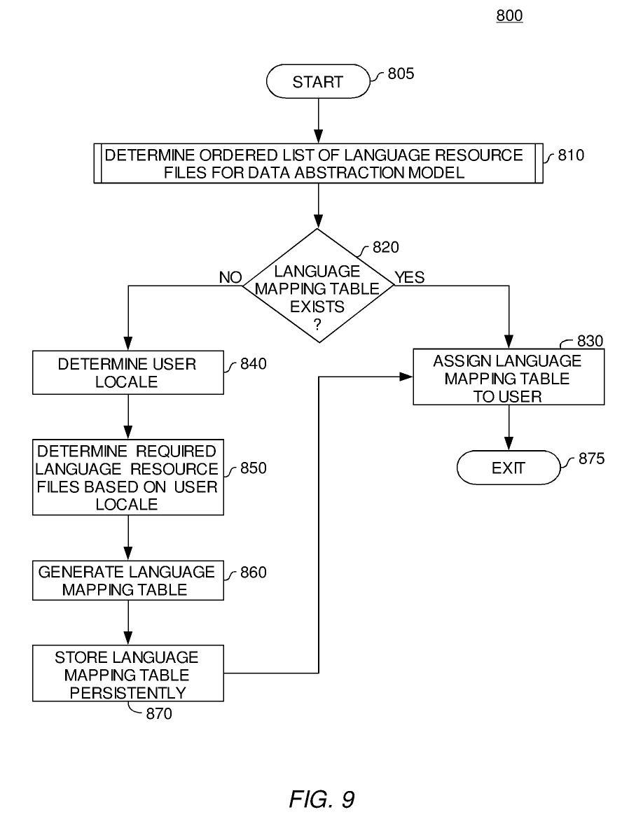

Referring now to FIG. 9, a method 800 illustrating determination of a language mapping table having suitable natural language expressions to be used for a given user is shown. The mapping table is determined from corresponding language resource components (e.g., language resource components 620, 635 and 645 of FIG. 7). By way of example, the method 800 is explained with reference to language resource files. In one embodiment, the method 800 is performed by the NLS manager 120 of FIG. 2. Method 800 starts at step 805.

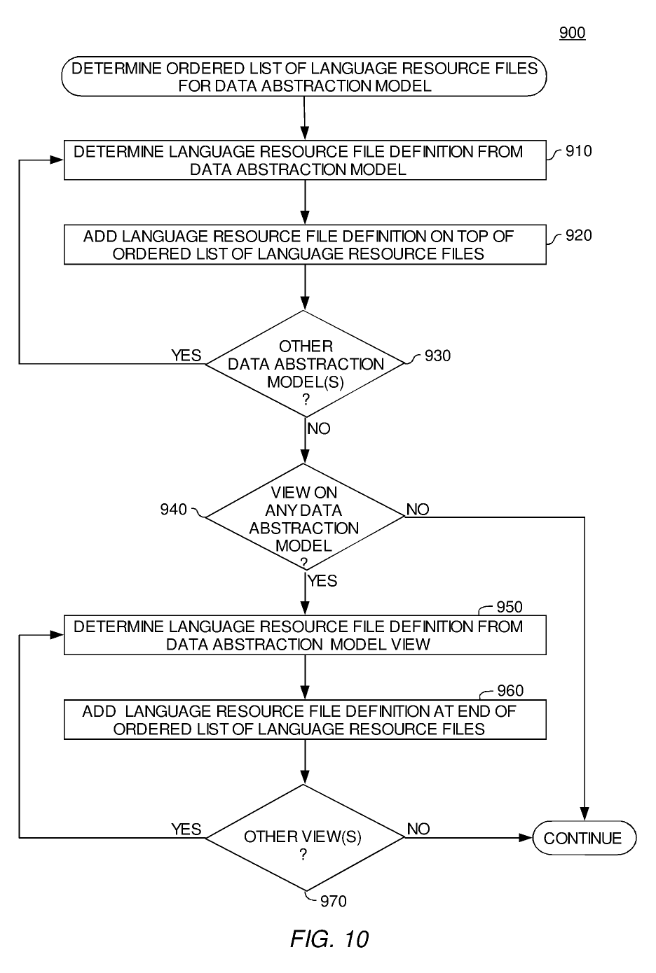

At step 810, an ordered list of the language resource files for a given data abstraction model is determined. Determination of the ordered list is described in more detail below with reference to FIG. 10.

At step 820, a determination is made as to whether a corresponding language mapping table for the user already exists. If the corresponding language mapping table already exists, it is assigned to the user in step 830. Method 800 then exits at step 875. If the corresponding language mapping table does not exist, processing continues at step 840.

At step 840, a user locale is determined. The user locale defines settings concerning, for example, country, language and a language variant used by the user. For instance, the locale may define the user as a researcher of a research group who uses the English language in the United States. In one embodiment, the locale is determined according to user input including suitable parameters for determination of all required language resource files using a user interface. In another embodiment, the locale is determined according to local user settings on his/her workstation.

At step 850, all required language resource files are determined for the user based on the determined user locale. For purposes of illustration, it will be assumed that the language resource files of Tables IV and VI are determined for the researcher.

At step 860, using the determined language resource files, a language mapping table is generated for the user. To this end, in one embodiment all definition/value mappings of the least specific language resource file are included in the language mapping table. For instance, all definition/value mappings of the language resource file of Table IV are initially included in the language mapping table. Subsequently, definition/value mappings of more specific language resource files are used to replace the less specific definition/value mappings of less specific language resource files. This process is performed until all definition/value mappings in the most specific language resource file have been processed. For instance, in the given example, the less specific definition/value mappings from the language resource file of Table IV are replaced by more specific definition/value mappings of the language resource file of Table VI. Accordingly, for the researcher of the research group, the exemplary language mapping table according to Table XI below can be generated.

TABLE XI
MAPPING TABLE EXAMPLE

| | |
|---|---|
| 001 | RESEARCH-MAPPING.xml |
| 002 | “Demographic.Gender:name” = “Gender” |
| 003 | “Demographic.Gender:val-Female” = “Female” |
| 004 | “Demographic.Gender:val-Male” = “Male” |
| 005 | “Demographic.Gender:val-Unknown” = “Unknown” |
| 006 | “Demographic.Name:name” = “Subject name” |
| 007 | “Demographic.SSN:description” = “This is the patient's |
| | social security number” |
| 008 | “Demographic.SSN:name” = “SSN” |
| 009 | “Demographic:description” = “Demographic” |
| 010 | “Demographic:name” = “Demographic” |
| 011 | “Diagnosis.Disease.Name:name” = “Syndrome name” |
| 012 | “Diagnosis.Disease:name” = “Disease” |
| 013 | “Diagnosis:description” = “Diagnostic information” |
| 014 | “Diagnosis:name” = “Diagnosis” |

As can be seen from Table XI, the exemplary language mapping table represents a combination of the language resource files of Tables IV and VI. The loading and processing of language resource files using locales for file or resource names for generation of a language mapping table is well-known in the art (e.g., by a Java language runtime implementation of resource bundles) and will, therefore, not be described in more detail.

At step 870, the generated language mapping table is persistently stored in memory for use by all users having the same user locale. For instance, the language mapping table of Table XI is persistently stored for all users of the research group. Thus, each time a research group user loads the effective data abstraction model of the research group, the language mapping table can be used for translation purposes. Processing then continues at step 830 as described above.

Referring now to FIG. 10, a method 900 illustrating the determination of the ordered list of the language resource files for a given data abstraction model (e.g., data abstraction model 610 of FIG. 7) according to step 810 of FIG. 9 is shown. In one embodiment, the ordered list is determined for all users of a given group having common group security settings. Method 900 starts at step 910.

At step 910, a language resource file definition is determined from the data abstraction model. For instance, the language resource file definition “ABC-XLIFF.xml” can be determined from the exemplary data abstraction model of Table III (line 013). At step 920, the determined language resource file definition is added on top of the ordered list of language resource files. At step 930, it is determined whether other data abstraction models exist. If one or more other data abstraction models exist, a next data abstraction model is selected and processing returns to step 910. Accordingly, steps 910 to 930 form a loop which is executed until all data abstraction models have been processed. By way of example, assume that another data abstraction model “DEF-DAM” having a language resource file definition “DEF-XLIFF.xml” exists. Accordingly, the language resource file definition “DEF-XLIFF.xml” is placed on top of the ordered list before the language resource file definition “ABC-XLIFF.xml”. When it is determined, at step 930, that no more data abstraction models exist, processing continues at step 940.

At step 940, it is determined whether one or more views on one or more data abstraction models, which have been processed in the loop formed of steps 910 to 930, exist. If no view exists, processing continues at step 820 of FIG. 9. If, however, one or more views exist, a language resource file definition from a first view is determined at step 950. For instance, the language resource file definition “RESEARCH-XLIFF.xml” can be determined from the exemplary view of Table V (line 005). At step 960, the determined language resource file definition is added at the end of the ordered list. At step 970, it is determined whether other views exist. If one or more other views exist, a next view is selected and processing returns to step 950. Accordingly, steps 950 to 970 form a loop which is executed until all views have been processed. In one embodiment, step 970 includes determining whether other views exist for a given group of users. For instance, it is determined whether other views exist for the research group users. In the given example no additional views for research group users can be determined, but a view for social service group users can be determined. By way of example, the “SOCIAL-VIEW” of Table VIII includes the language resource file definition “SOCIAL-XLIFF.xml” (line 004). However, in the given example it is assumed that the views of the research group and the social service group have different group security settings and are mutually exclusive. Therefore, the language resource file definition “SOCIAL-XLIFF.xml” is not processed. However, if the views of the research group and the social service had been construed with common group security settings, the language resource file definition “SOCIAL-XLIFF.xml” would have been placed at the end of the ordered list behind the language resource file definition “RESEARCH-XLIFF.xml”. When it is determined, at step 970, that no more views exist, processing continues at step 820 of FIG. 9.

In one embodiment, the loop formed of steps 950 to 970 is performed for views of different specificity levels. In other words, after processing a first view at a lowest specificity level, views of higher specificity levels up to views having the highest specificity level can be processed before a next view at the lowest specificity level is processed. It should be noted that identical processing can be performed for the data abstraction models by the loop formed of steps 910 to 930. For instance, assume that a view for a Russian research group having a language resource file definition “RESEARCH-XLIFF_RU.xml” exists. Assume further that a view for a Russian research group of a region BB exists, which requires a more specific terminology and which has a language resource file definition “RESEARCH-XLIFF_RU_BB.xml”. Accordingly, the language resource file definition “RESEARCH-XLIFF_RU.xml” would be processed after the language resource file definition “RESEARCH-XLIFF.xml”, and the language resource file definition “RESEARCH-XLIFF_RU_BB.xml” would be processed at the end. Accordingly, the language resource file definition “RESEARCH-XLIFF_RU_BB.xml” would be placed at the end of the ordered list. The following Table XII exemplifies an ordered list according to the above example.

TABLE XII
ORDERED LIST EXAMPLE

| | |
|---|---|
| 001 | DEF-XLIFF.xml |
| 002 | DEF-XLIFF_RU.xml |
| 003 | DEF-XLIFF_RU_BB.xml |
| 004 | ABC-XLIFF.xml |
| 005 | ABC-XLIFF_RU.xml |
| 006 | ABC-XLIFF_RU_BB.xml |
| 007 | RESEARCH-XLIFF.xml |
| 008 | RESEARCH-XLIFF_RU.xml |
| 009 | RESEARCH-XLIFF_RU_BB.xml |

It should be noted that Table XII includes language resource file definitions for the data abstraction models “DEF-DAM” (lines 001-003) and “ABC-DAM” (lines 004-006) with specificity levels that correspond to the specificity levels of the “RESEARCH-VIEW” of Table V as explained above. In other words, it is assumed that a general Russian translation (lines 002 and 005) and a more specific Russian translation for a region BB (lines 003 and 006) are also provided for each of the data abstraction models. “DEF-DAM” and “ABC-DAM”.

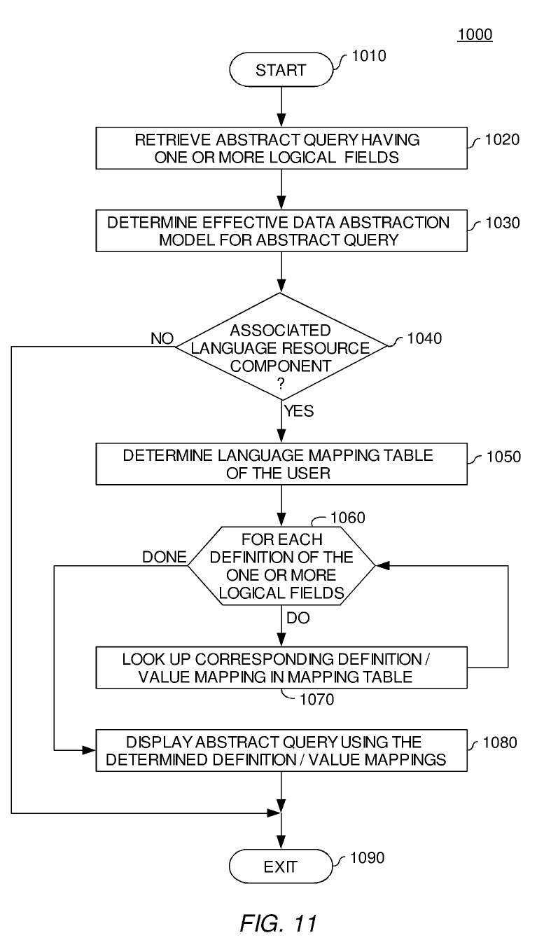

Referring now to FIG. 11, one embodiment of a method 1000 of providing natural language support for users running queries (e.g., abstract query 170 of FIG. 2) against a database (e.g., database 130 of FIG. 2) is illustrated. At least a portion of the steps of method 1000 can be performed by the NLS manager 120 of FIG. 2. Method 1000 starts at step 1010.

At step 1020, an abstract query (e.g., abstract query 170 of FIG. 2) including one or more logical fields, each corresponding to a logical field specification of a data abstraction model (e.g., data abstraction model 124 of FIG. 2 or data abstraction model 610 of FIG. 7) abstractly describing physical data residing in a database (e.g., database 130 of FIG. 2) is retrieved. At step 1030, the data abstraction model is determined. This determination can be performed by a database application (e.g., application 190 of FIG. 2) that is configured to access the data abstraction model and has corresponding knowledge of which data abstraction model(s) to use. Furthermore, based on security settings for users and user and group information for a corresponding user, applicable views can be determined by the application. At step 1040, it is determined, from the data abstraction model, whether an associated language resource component (e.g., language resource file 620 of FIG. 7) exists. If no associated language resource component exists, the method 1000 exits at step 1090. If, however, an associated language resource component exists, processing continues at step 1050.

At step 1050, a corresponding language mapping table is determined for the user. Determination of the language mapping table is performed, in one embodiment, according to the method 800 of FIG. 9. The method 1000 then enters a loop consisting of steps 1060 and 1070. The loop is performed for each attribute of each logical field of the abstract query to determine a natural language expression for the logical field(s) of the abstract query. More specifically, for each attribute of each logical field, a corresponding definition is determined at step 1060. Then, at step 1070, a corresponding definition/value mapping is looked up in the language mapping table. When all attributes have been processed, processing continues at step 1080.

At step 1080, the abstract query is displayed in the determined natural language expression. More specifically, each attribute in the abstract query is replaced by a determined value from a corresponding definition/value mapping from the language mapping table for display. Method 1000 then exits at step 1090.

Natural Language Support with Respect to Foreign Languages

Referring now to FIG. 12, an exemplary screenshot 1200 illustrating a graphical user interface (GUI) screen displayed by a suitable user interface (e.g., user interface 160 of FIG. 2) for query creation is shown. Illustratively, the GUI screen 1200 displays a panel 1210 for creation of an abstract query (e.g., abstract query 170 of FIG. 2) against an underlying database (e.g., database 130 of FIG. 2).

As was noted above, in one embodiment a language resource component (e.g., language resource component 150 of FIG. 2) for a given data abstraction model (e.g., data abstraction model 124 of FIG. 2) can be defined by a language resource file. The language resource file may include default natural language expressions for use in representing attributes of the data abstraction model to the user. In one embodiment, the default natural language expressions can be translated into any foreign languages or variants on a same language such as alternative terminology required by users or groups of users that access the data abstraction model. Furthermore, in one embodiment a given language resource component can be used to translate basic constructs of the underlying database and corresponding user interfaces that are suitable for query creation into a given foreign language, not just user application data. For example, field names used for comparison, comparison operators or database attributes can be automatically translated into the foreign language.

In one embodiment, a suitable language resource file(s) that is used to translate the data abstraction model or a given view is retrieved at startup/load time. At user login time, user-specific settings for the user are retrieved, such as from a user locale, and which translated resources are used for representing the data abstraction model is determined.

For instance, assume that an underlying user locale defines that a given user of the underlying database uses the Spanish language in the United States. Assume further that a given language resource component is configured to translate all basic constructs of the underlying database and corresponding user interfaces for query creation into the Spanish language. Furthermore, a suitable language resource file translates all attributes of an underlying data abstraction model into the Spanish language. By way of example, assume that the underlying data abstraction model is the exemplary data abstraction model of Table III above. Accordingly, all information shown in the panel 1210 is displayed in the Spanish language.

It should be noted that the panel 1210 illustratively includes a display area 1220 that is configured for specification of a query condition for the abstract query. By way of example, the display area 1220 is used to specify a query condition on the “Gender” field of the underlying data abstraction model. Assume now that a translation in the Spanish language is retrieved for all attributes of all logical fields of the exemplary data abstraction model of Table III above in the exemplary language resource file “SPANISH-XLIFF.xml” shown in Table XIII below. For simplicity, elements of the “SPANISH-XLIFF.xml” language resource file are represented in a shorthand format. Persons skilled in the art will readily recognize corresponding XML representations. Further, for brevity, only parts that are relevant for the following explanations are shown, i.e., parts relating to the “Gender” field of the exemplary data abstraction model of Table III above.

TABLE XIII
SPANISH-XLIFF FILE EXAMPLE

| | |
|---|---|
| 001 | SPANISH-XLIFF.xml |
| 002 | “Demographic.Gender:name” = “Género” |
| 003 | “Demographic.Gender:val-Female” = “Hembra” |
| 004 | “Demographic.Gender:val-Male” = “Varón” |
| 005 | “Demographic.Gender:val-Unknown” = “Desconocido” |
| 006 | “Demographic.Name:name” = “Apellido” |

The exemplary XLIFF language resource file of Table XIII illustratively includes Spanish expressions for each attribute included in the “Gender” field and the “Name” field of the exemplary data abstraction model of Table III. More specifically, the exemplary XLIFF language resource file includes in lines 002-005, on the left hand side of each line, a definition for an element (e.g., a logical field name or value) of the “Gender” field and, on the right hand side of each line, an associated Spanish expression. Similarly, in line 006 a definition for the logical field name of the “Name” field is associated with a corresponding Spanish expression.

In the given example, using the exemplary “SPANISH-XLIFF.xml” file of Table XIII, the display area 1220 displays an indication 1230 of the logical field name “Gender” (line 003 of Table III) using the Spanish expression “Género” (line 002 of Table XIII). Furthermore, indications of all alternative values associated with allowed physical values for the “Gender” field according to lines 004-006 of Table III are displayed in the display area 1220. Accordingly, an indication 1240 of the value “Female” (line 004 of Table II) using the Spanish expression “Hembra” (line 003 of Table XIII), an indication 1250 of the value “Male” (line 005 of Table III) using the Spanish expression “Varón” (line 004 of Table XIII) and an indication 1260 of the value “Unknown” (line 006 of Table III) using the Spanish expression “Desconocido” (line 005 of Table XIII) are displayed.

In the display area 1220, the indications 1240, 1250 and 1260 are each associated with a corresponding user-selectable checkbox 1245, 1255 and 1265. Illustratively, the checkbox 1255 associated with the indication 1250 “Varón” is selected. Furthermore, a comparison operator “=iguales” is selected from a list 1270 of user-selectable operators for definition of the query condition. By activating a pushbutton 1280 “Actualización”, the user requests creation of the query condition.

Referring now to FIG. 13, the GUI screen 1200 of FIG. 12 is shown after user-activation of the pushbutton 1280 “Actualización”. Accordingly, the query condition is created and a summary 1310 thereof is shown in a display area 1320 of the panel 1210.

After specification of all query conditions and selection of required result fields, creation of the abstract query is completed. Assume now that the illustrative abstract query shown in Table XIV below is created using the GUI screen 1200 of FIGS. 12-13. By way of illustration, the illustrative abstract query is defined using XML. However, any other language may be used to advantage.

TABLE XIV
ABSTRACT QUERY EXAMPLE

| | |
|---|---|
| 001 | <?xml version=“1.0”?> |
| 002 | <QueryAbstraction> |
| 003 | <Selection> |
| 004 | <Condition relOperator=“AND” fieldType=“char” |
| 005 | field=“Gender” operator=“EQ”> <Value |
| | val=“Male”/> |
| 006 | </Condition> |
| 007 | </Selection> |
| 008 | <Results> |
| 009 | <Field name=“Name”/> |
| 010 | <Field name=“Gender”/> |
| 011 | </Results> |
| 012 | </QueryAbstraction> |

Illustratively, the abstract query shown in Table XIV includes in lines 003-007 a selection specification containing the query condition that was created using the exemplary GUI screen 1200 of FIGS. 12-13 and in lines 008-011 a results specification. By way of example, the results specification in lines 008-011 requests name and gender information for patients in a hospital and refers to the “Name” field (line 007 of Table III) and the “Gender” field (line 003 of Table III) of the exemplary data abstraction model of Table III above.

It should be noted that all attributes in the exemplary abstract query of Table XIV are defined in the English language, i.e., the default language of the data abstraction model, although the abstract query shown in Table XIV was created using the GUI screen 1200 of FIGS. 12-13 that uses the Spanish language. In fact, in one embodiment abstract queries are only generated in the default language that is defined by the underlying data abstraction model to allow transformation of the abstract query into an executable query using the data abstraction model. As the default language of the exemplary data abstraction model of Table III is English, the exemplary abstract query of Table XIV is generated in English. This allows normalization of generated abstract queries and further allows database administrators, security officers and suitable security monitoring equipment to monitor the generated abstract queries regarding data security.

If the exemplary abstract query of Table XIV is transformed into an executable query that is executed against the underlying database, a query result in the default language (i.e., in the given example English) is obtained (e.g., default language result set 174 of FIG. 2). In order to output the query result in the natural language of the user (i.e., in the given example Spanish), further processing is required as described by way of example below with reference to FIGS. 14-17.

Natural Language Support Using User-Defined Functions

Referring now to FIG. 14, one embodiment of a method 1400 for generating UDFs (e.g., UDFs 152 of FIG. 2) configured for providing natural language support for users running queries (e.g., abstract query 170 of FIG. 2) is illustrated. The UDFs are generated for an underlying data abstraction model (e.g., data abstraction model 124 of FIG. 2) that abstractly describes physical data (e.g., data 132 of FIG. 2) in one or more associated databases (e.g., database 130 of FIG. 2). In one embodiment, the method 1400 is performed by the NLS manager 120 of FIG. 2. Method 1400 starts at step 1410.

At step 1420, the underlying data abstraction model which provides definitions for a plurality of logical fields is retrieved. For instance, assume that in the given example the exemplary data abstraction model of Table III is retrieved. As was noted above, the exemplary data abstraction model of Table III includes a “Demographic” category (lines 002-008 of Table III) that includes definitions for a “Gender” (lines 003-006 of Table III), “Name” (line 007 of Table III) and “SSN” (line 008 of Table III) field.

At step 1430, a loop consisting of steps 1430 to 1460 is entered for each definition of the underlying data abstraction model that contains a mapping list of allowed physical values to alternative user-friendly values. In the given example, only the definition of the “Gender” field includes such a mapping list, as can be seen from lines 004-006 of Table III above. More specifically, the allowed physical values for the “Gender” field are the values “F”, “M” and “U”. As was noted above, these values are defined in a base language as actual values (“actualVal”) and correspond to physical data values in a “gender” column of a table included with the associated database(s). The allowed physical values “F”, “M” and “U” are respectively mapped to default language expressions “Female”, “Male” and “Unknown” (“val” in lines 004-006 of Table III). For instance, assume that in the given example the exemplary data abstraction model of Table III is configured for use of users in the United States, so that the default language is English.

In the given example, the loop consisting of steps 1430 to 1460 is initially entered for the definition of the “Gender” field. At step 1440, two base UDFs are generated on the basis of the mapping list included with the definition of the “Gender” field. A first base UDF is configured for translation of the allowed physical values in the base language into the alternative values in the default language (hereinafter referred to as “translate base UDF”, for simplicity). A second base UDF is configured for reverse translation, i.e., for translation of the alternative values in the default language back into the allowed physical values in the base language (hereinafter referred to as “translate-reverse base UDF”, for simplicity). An exemplary illustrative translate base UDF that is generated for the definition of the “Gender” field is shown in Table XV below.

TABLE XV
TRANSLATE BASE UDF EXAMPLE

| | |
|---|---|
| 001 | create function translate.mapgender |
| 002 | (inputVal varchar(1)) returns varchar(7) language sql no |
| 003 | external action deterministic |
| 004 | return ( |
| 005 | case inputVal |
| 006 | when ‘F’ then ‘Female’ |
| 007 | when ‘M’ then ‘Male’ |
| 008 | when ‘U’ then ‘Unknown’ |
| 009 | end) |

Illustratively, the exemplary translate base UDF shown in Table XV is invoked using the function name “translate.mapgender” in line 001. According to line 002, input values to the “translate.mapgender” UDF (i.e., the allowed physical values) are defined as variable characters of length “1” (“inputVal varchar(1)”). All output values (i.e., the alternative values) are defined as variable characters of length less or equal than “7” (“returns varchar(7)”). In lines 006-008 of Table XV, all required translations for the definition of the “Gender” field are enumerated.

An exemplary illustrative translate-reverse base UDF that is generated for the definition of the “Gender” field is shown in Table XVI below.

TABLE XVI
TRANSLATE-REVERSE BASE UDF EXAMPLE

| | |
|---|---|
| 001 | create function translate.mapgenderreverse |
| 002 | (inputVal varchar(7)) returns varchar(1) language sql no |
| 003 | external action deterministic |
| 004 | return ( |
| 005 | case inputVal |
| 006 | when ‘Female’ then ‘F’ |
| 007 | when ‘Male’ then ‘M’ |
| 008 | when ‘Unknown’ then ‘U’ |
| 009 | end) |

Illustratively, the exemplary translate-reverse base UDF shown in Table XVI is invoked using the function name “translate.mapgenderreverse” in line 001. Here, the suffix “reverse” indicates that the UDF is a translate-reverse UDF. The exemplary translate-reverse base UDF of Table XVI is configured similarly to the exemplary translate base UDF of Table XV above and, thus, not explained in more detail, for brevity.

At step 1450, a loop consisting of steps 1450 and 1460 is performed for each view on the underlying data abstraction model(s). Assume now that the loop is initially entered for a “SPANISH-VIEW” that is configured similarly to the exemplary views of Tables V and VIII above to provide a view of the exemplary data abstraction model of Table III to users using the Spanish language in the United States.

At step 1460, a language resource file definition is determined from the “SPANISH-VIEW” and retrieved. In the given example, the exemplary “SPANISH-XLIFF.xml” language resource file of Table XIII is retrieved. On the basis of the retrieved “SPANISH-XLIFF.xml” file, a translate and a translate-reverse UDF for translation from the base language to the Spanish language and vice versa are created for the “SPANISH-VIEW” of the definition of the “Gender” field. An exemplary illustrative translate UDF that is generated for the “SPANISH-VIEW” of the definition of the “Gender” field is shown in Table XVII below.

TABLE XVII
TRANSLATE UDF EXAMPLE

| | |
|---|---|
| 001 | create function translate.mapgender_ES |
| 002 | (inputVal varchar(1)) returns varchar(11) language sql no |
| 003 | external action deterministic |
| 004 | return ( |
| 005 | case inputVal |
| 006 | when ‘F’ then ‘Hembra’ |
| 007 | when ‘M’ then ‘Varon’ |
| 008 | when ‘U’ then ‘Desconocido’ |
| 009 | end) |

Illustratively, the exemplary translate UDF shown in Table XVII is invoked using the function name “translate.mapgender_ES” in line 001. Here, the suffix “_ES” indicates that the UDF is configured for translations from the base language to the Spanish language. Note that in lines 006-008 of Table XVII, all required translations for the allowed physical values of the “Gender” field to corresponding alternative values in the Spanish language are illustrated, i.e., from “F” to “Hembra” (line 006), from “M” to “Varón” (line 007) and from “U” to “Desconocido” (line 008).

An exemplary illustrative translate-reverse UDF for translation from alternative Spanish values back to allowed physical values in the base language that is generated for the definition of the “Gender” field is shown in Table XVIII below.

TABLE XVIII
TRANSLATE-REVERSE UDF EXAMPLE

| | |
|---|---|
| 001 | create function translate.mapgenderreverse_ES |
| 002 | (inputVal varchar(11)) returns varchar(1) language sql no |
| 003 | external action deterministic |
| 004 | return ( |
| 005 | case inputVal |
| 006 | when ‘Hembra’ then ‘F’ |
| 007 | when ‘Varon’ then ‘M’ |
| 008 | when ‘Desconocido’ then ‘U’ |
| 009 | end) |

The exemplary translate-reverse UDF of Table XVIII is configured similarly to the exemplary translate-reverse base UDF of Table XVI above and, thus, not explained in more detail, for brevity.

Processing then returns to step 1450, where the loop consisting of steps 1450 and 1460 is entered for a next view on the underlying data abstraction model. In the given example, the loop may thus be performed subsequently for the exemplary “RESEARCH-VIEW” of Table V and the exemplary “SOCIAL-VIEW” of Table VIII above. When it is determined, at step 1450, that no more views of the underlying data abstraction model exist, processing returns to step 1430.

Once the loop consisting of steps 1430 to 1460 is performed for all definitions of the underlying data abstraction model that contain a mapping list of allowed physical values to alternative user-friendly values, processing continues at step 1470. As in the given example only the definition of the “Gender” field includes a mapping list, processing thus proceeds with step 1470.

At step 1470, each definition of a logical field provided by the underlying data abstraction model that contains a mapping list is associated with the UDFs that were generated for the logical field. In the given example, the exemplary UDFs of Tables XV-XVIII are associated with the “Gender” field. Processing then exits at step 1480.

Natural Language Support Using User-Defined Functions

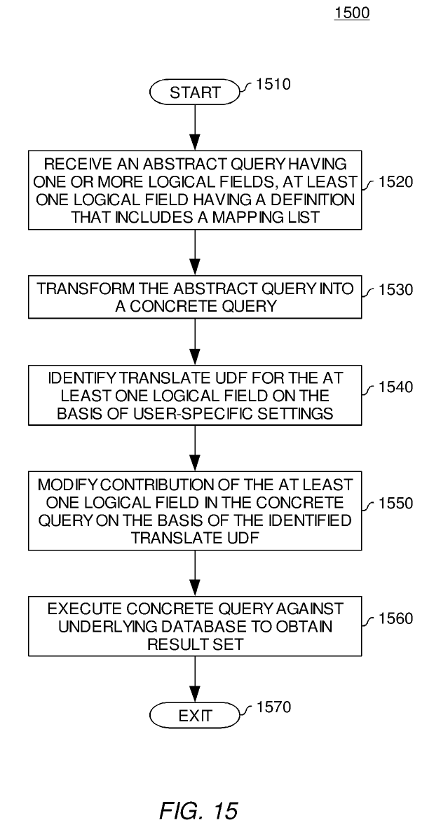

Referring now to FIG. 15, one embodiment of a method 1500 of providing natural language support using suitable UDFs (e.g., UDFs 152 of FIG. 2) for users running queries against a database (e.g., database 130 of FIG. 2) is illustrated. At least a portion of the steps of method 1500 can be performed by the runtime component 126 and/or the NLS manager 120 of FIG. 2. Method 1500 starts at step 1510.

At step 1520, an abstract query (e.g., abstract query 170 of FIG. 2) including one or more logical fields, each corresponding to a logical field specification of an underlying data abstraction model (e.g., data abstraction model 124 of FIG. 2) is received. At least one result field included with the abstract query refers to a logical field that includes a mapping list of allowed physical values to alternative user-friendly values. By way of example, assume that the exemplary abstract query of Table XIV is received at step 1520. As was noted above, the exemplary abstract query shown in Table XIV includes in line 007 the result field “Gender” that refers to the “Gender” field of the exemplary data abstraction model of Table III having a mapping list of allowed physical values to alternative user-friendly values (lines 004-006 of Table III).

At step 1530, the received abstract query is transformed into an executable query. In one embodiment, the transformation is performed by the runtime component 126 of FIG. 2 as described above with reference to FIGS. 5-6. In the given example, the exemplary abstract query of Table XIV is transformed into the exemplary executable query of Table XIX below. By way of illustration, the illustrative executable query is defined using SQL. However, any other language such as XML may be used to advantage.

TABLE XIX
EXECUTABLE QUERY EXAMPLE

| | |
|---|---|
| 001 | SELECT DISTINCT |
| 002 | “t1”.“lastname” AS “Apellido”, |
| 003 | “t1”.“gender” AS “Género” |
| 004 | FROM |
| 005 | “Patientinfo” “t1” |
| 006 | WHERE |
| 007 | “t1”.“gender” = ‘M’ |

Illustratively, the exemplary executable query of Table XIX includes a results specification in lines 001-003 requesting data from a “gender” column (line 002) and a “lastname” column (line 003) of an underlying “Patientinfo” table (line 004). Assume now that data in the “gender” column is abstractly described by the “Gender” field of the underlying data abstraction model of Table III (lines 003-006 of Table III). Assume further that data in the “lastname” column is abstractly described by the “Name” field of the underlying data abstraction model of Table III (line 007 of Table III). Note that the columns are associated with Spanish language translations of the corresponding logical field names (i.e., “Apellido” and “Género”) so that they are displayed in a corresponding result set (e.g., natural language result set 172 of FIG. 2) in the Spanish language. In the given example, these Spanish language translations are determined from the exemplary “SPANISH-XLIFF.xml” language resource file of Table XIII.

The exemplary executable query of Table XIX further includes a selection specification in line 007 that corresponds to the query condition in line 005 of the exemplary abstract query of Table XIV. In the given example, the selection specification restricts returned “name” and “gender” information to information for patients in a hospital having the gender “Male” (“M”).

At step 1540, the at least one result field included with the abstract query that refers to a logical field having a mapping list of allowed physical values to alternative user-friendly values is identified. Furthermore, one or more suitable translate UDFs associated with the logical field are identified. In one embodiment, the suitable translate UDF(s) is identified on the basis of user-specific settings. As was noted above, the user-specific settings can be defined by a user locale defining settings concerning, for example, roles, authorizations, country, language and/or a language variant used by the user. The user-specific settings may further include information about a view of the underlying data abstraction model that is to be displayed to the user.

In the given example, the “Gender” result field (line 010 of Table XIV) is identified that refers to the “Gender” field of the exemplary data abstraction model of Table III (lines 004-006 of Table III). Furthermore, assuming that in the given example the user-specific settings identify the user as a user using the Spanish language in the United States, the exemplary translate UDF of Table XVII is identified and retrieved.

At step 1550, a contribution of the identified result field in the executable query is identified and associated with the identified translate UDF. In the given example, the contribution in line 003 of the exemplary executable query in Table XIX is identified.

By associating the identified contribution with the exemplary translate UDF of Table XVII, the modified executable query of Table XX below is generated. By way of illustration, the modified executable query is defined using SQL. However, any other language such as XML may be used to advantage.

TABLE XX
MODIFIED EXECUTABLE QUERY EXAMPLE

| | |
|---|---|
| 001 | SELECT DISTINCT |
| 002 | “t1”.“lastname” AS “Apellido”, |
| 003 | translate.mapgender_ES(“t1”.“gender”) AS “Género” |
| 004 | FROM |
| 005 | “Patientinfo” “t1” |
| 006 | WHERE |
| 007 | “t1”.“gender” = ‘M’ |

In contrast to the exemplary executable query of Table XIX, the exemplary modified executable query of Table XX invokes the exemplary translate UDF “translate.mapgender_ES” of Table XVII in line 003. Thus, in one embodiment all allowed physical values in the base language that are retrieved from the “gender” column at query execution time are immediately translated into corresponding alternative values in the Spanish language as defined by the exemplary translate UDF of Table XVII. Thus, only Spanish language expressions are output in a corresponding natural language result set (e.g., natural language result set 172 of FIG. 2) obtained in response to execution of the exemplary modified executable query of Table XX. Alternatively, a default language result set (e.g., default language result set 174 of FIG. 2) is initially determined and the exemplary translate UDF of Table XVII is then executed on the default language result set to determine the natural language result set. All such implementations are broadly contemplated.

At step 1560, the modified executable query is executed against the database and the obtained natural language result set is returned to the user (e.g., application 190 of FIG. 2). In one embodiment, the modified executable query of Table XX is executed using the query execution unit 180 of FIG. 2. Method 1500 then exits at step 1570.

FIG. 16 illustrates an exemplary GUI screen 1600 having a display area 1610 displaying an illustrative natural language result set 1620. The result set 1620 exemplifies the natural language result set which is obtained by executing the exemplary modified executable query of Table XX against a corresponding “Patientinfo” table (line 005 of Table XX) in an underlying database at step 1560 of FIG. 15.

According to lines 002 and 003 of Table XX, the result set 1620 has an “Apellido” column 1630 and a “Género” column 1640. The “Apellido” column 1630 includes last names that were retrieved from the “Patientinfo” table. The “Género” column 1640 only includes the Spanish expression “Varón” which is associated with the base language expression “M” (line 007 of Table XVII) as requested by the query condition in line 007 of Table XX.

Natural Language Support for Query Results

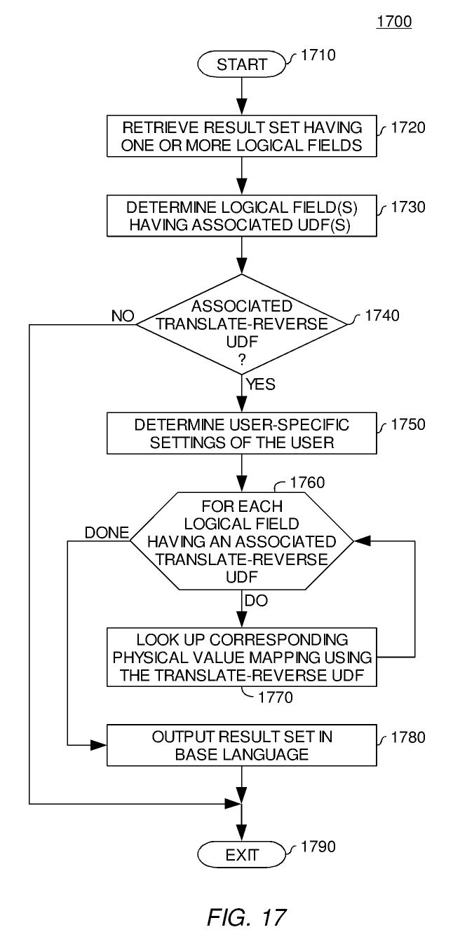

Referring now to FIG. 17, one embodiment of a method 1700 of providing natural language support for users storing obtained query results provided in a given natural language (e.g., natural language result set 172 of FIG. 2) is illustrated. At least a portion of the steps of method 1700 can be performed by the NLS manager 120 of FIG. 2. Method 1700 starts at step 1710.

At step 1720, a request for storing an obtained query result provided in a given natural language (e.g., natural language result set 1620 of FIG. 16) having data for one or more result fields is received and the query result is accessed. At least one of the result fields refers to a corresponding logical field in an underlying data abstraction model (e.g., data abstraction model 124 of FIG. 2) that includes a mapping list of allowed physical values to alternative user-friendly values.

At step 1730, the at least one of the result fields is identified and the corresponding logical field(s) is determined. On the basis of the determined logical field(s), one or more UDFs (e.g., UDFs 152 of FIG. 2) that are associated with the logical field(s) and, thus, with the identified result field(s) are retrieved. By way of example, assume that the exemplary query result 1620 illustrated in FIG. 16 is retrieved. In this case, the identified result field is the “Género” field that refers to the “Gender” field in the exemplary data abstraction model of Table III (lines 004-006 of Table III). Accordingly, in the given example the exemplary UDFs of Tables XV-XVIII are retrieved.

At step 1740, it is determined whether one or more translate-reverse UDFs are associated with the identified result field(s). If so, processing continues at step 1750. Otherwise, the method 1700 exits at step 1790. However, in the given example, the translate-reverse UDFs of Tables XVI and XVIII are associated with the “Género” result field so that processing proceeds with step 1750.

At step 1750, user-specific settings of the user for which the query result was created are identified to determine which translate-reverse UDF is required for reverse-translation. As was noted above, in the given example the user-specific settings identify the user as a user using the Spanish language in the United States. Thus, the exemplary translate-reverse UDF of Table XVIII is retrieved.

At step 1760, a loop consisting of steps 1760 and 1770 is performed for each identified result field having an associated translate-reverse UDF. In the given example, the loop is initially entered for the “Género” result field that is associated with the exemplary translate-reverse UDF of Table XVIII.

At step 1770, each natural language expression of the identified result field is reverse-translated into a corresponding base language expression using the associated translate-reverse UDF. In the given example, the “Género” result field only includes the natural language expression “Varón”. This expression is translated into the base language expression “M” according to line 007 of the exemplary translate-reverse UDF of Table XVIII.

Once all natural language expressions of the “Género” result field are reverse-translated, the loop consisting of steps 1760 and 1770 is entered for a next identified result field. Accordingly, the loop is executed until all natural language expressions occurring in the query result are reverse-translated into corresponding base language expressions. Thus, a base language result set is generated.

Once the loop consisting of steps 1760 and 1770 is performed for all identified result fields, processing proceeds with step 1780, where the generated base language result set is output for storing. Storing the query result in the base language allows normalization of generated query results and further allows database administrators, security officers and suitable security monitoring equipment to monitor the generated query results regarding data security. Method 1700 then exits at step 1790.

It should be noted that various modifications are possible. For instance, instead of reverse-translating the natural language query result into the corresponding base language, it can also be reverse-translated into an underlying default language. By way of example, instead of reverse-translating the natural language expression “Varón” into the base language expression “M” according to line 007 of the exemplary translate-reverse UDF of Table XVIII, it can be reverse-translated into the default language expression “Male” using a suitable UDF. Thus, the query result can be stored in the default language as a default language result set. All such implementations are broadly contemplated.

It should be noted that any reference herein to particular values, definitions, programming languages and examples is merely for purposes of illustration. Accordingly, the invention is not limited by any particular illustrations and examples. Furthermore, while the foregoing is directed to embodiments of the present invention, other and further embodiments of the invention may be devised without departing from the basic scope thereof, and the scope thereof is determined by the claims that follow.

What is claimed is:

1. A computer-implemented method of providing language transformation support for a query result obtained in response to execution of a query against an underlying database containing physical data, comprising:
identifying one or more physical values defined by the physical data for the query result for the executed query;
retrieving a user-defined function configured to transform the one or more identified physical values from a first language defined by the physical data in the underlying database into alternative values defined in a second language; and
outputting the query result in the second language on the basis of the user-defined function.

2. The method of claim 1, wherein retrieving the user-defined function comprises:
identifying user-specific settings associated with the user issuing the query; and
determining the user-defined function on the basis of the identified user-specific settings.

3. The method of claim 1, further comprising:
retrieving a language resource component mapping the one or more allowed physical values to the alternative values; and
generating the user-defined function on the basis of the language resource component.

4. The method of claim 1, wherein the query is an abstract query comprising a plurality of logical fields defined by a data abstraction model abstractly describing the physical data in the underlying database, the method further comprising:
identifying, from the plurality of logical fields, at least one logical field having one or more allowed physical values defined by the physical data in the database;
retrieving a language resource component configured to transform the one or more allowed physical values into intermediate values defined in a third natural language; and
generating the user-defined function on the basis of the language resource component.

5. The method of claim 4, further comprising:
transforming the abstract query into an executable query capable of being executed against the database;
identifying a contribution defined for the at least one logical field in the executable query; and
associating the identified contribution in the executable query with the first language resource component, wherein the executable query is executed against the underlying database.

6. The method of claim 1, further comprising:
receiving a request for further processing of the outputted query result;
retrieving a reverse language resource component configured to transform the alternative values included with the outputted query result into allowed physical values defined by the physical data in the underlying database;
transforming the alternative values of the outputted query result into corresponding allowed physical values using the reverse language resource component; and
outputting the query result including only physical values for further processing.

7. A computer-readable medium containing a program which, when executed by a processor, performs a process of providing natural language support for users running queries against a database, the process comprising:
receiving, from a user, an abstract query comprising a plurality of logical fields defined by a data abstraction model abstractly describing physical data in the database,
identifying, from the plurality of logical fields, at least one logical field having one or more allowed physical values defined by the physical data in the database;
retrieving a first language resource component configured to transform the one or more allowed physical values into alternative values defined in a first natural language;
transforming the abstract query into an executable query capable of being executed against the database;
as a result of executing the executable query against the database, obtaining a result set including at least one portion of the one or more allowed physical values; and
outputting the result set in the first natural language on the basis of the first language resource component.

8. The computer-readable medium of claim 7, wherein retrieving the first language resource component comprises:
identifying user-specific settings associated with the user issuing the abstract query; and
determining the first language resource component on the basis of the identified user-specific settings.

9. The computer-readable medium of claim 7, wherein the first language resource component is a user-defined function configured to transform the one or more allowed physical values into the alternative values defined in the first natural language.

10. The computer-readable medium of claim 9, wherein the process further comprises:
retrieving a second language resource component mapping the one or more allowed physical values to the alternative values; and
generating the user-defined function on the basis of the second language resource component.

11. The computer-readable medium of claim 7, wherein executing the executable query comprises:
transforming the at least one portion of the one or more allowed physical values into the alternative values defined in the first natural language using the first language resource component.

12. The computer-readable medium of claim 7, wherein the one or more allowed physical values of the at least one logical field are mapped to one or more alternative values in a second natural language.

13. The computer-readable medium of claim 7, wherein transforming the abstract query into an executable query comprises:
identifying a contribution defined for the at least one logical field in the executable query; and
associating the identified contribution in the executable query with the first language resource component.

14. A computer-readable medium containing a program which, when executed by a processor, performs a process of providing natural language support for users processing query results, the process comprising:
retrieving a query result including one or more user-friendly values defined in a first natural language;
transforming the one or more user-friendly values into corresponding physical values consistent with physical data in an underlying database; and
outputting the query result including only the corresponding physical values.

15. The computer-readable medium of claim 14, wherein the transforming is done by a user-defined function configured to transform the one or more user-friendly values into the corresponding physical values.

16. The computer-readable medium of claim 14, wherein the transforming is done by a language resource component retrieved on the basis of user-specific settings associated with a user requesting the processing of the query result.

17. The computer-readable medium of claim 16, wherein the user-specific settings comprise at least one of: (i) a role of the user; (ii) a language setting of the user; and (iii) a data abstraction model view defined for the user.

18. The computer-readable medium of claim 16, wherein the language resource component is defined for a logical field defined by a data abstraction model abstractly describing physical data in the database, the logical field defining the one or more user-friendly values.

19. A computer-readable medium containing a program which, when executed by a processor, performs a process of providing language transformation support for a query result obtained in response to execution of a query against an underlying database containing physical data, the process comprising:
identifying one or more physical values defined by the physical data for the query result for the executed query;
retrieving a user-defined function configured to transform the one or more identified physical values from a first language defined by the physical data in the underlying database into alternative values defined in a second language; and
outputting the query result in the second language on the basis of the user-defined function.

20. The computer-readable medium of claim 19, wherein retrieving the user-defined function comprises:
identifying user-specific settings associated with the user issuing the query; and
determining the user-defined function on the basis of the identified user-specific settings.

21. The computer-readable medium of claim 19, wherein the process further comprises:
retrieving a language resource component mapping the one or more allowed physical values to the alternative values; and
generating the user-defined function on the basis of the language resource component.

22. The computer-readable medium of claim 19, wherein the query is an abstract query comprising a plurality of logical fields defined by a data abstraction model abstractly describing the physical data in the underlying database, the method further comprising:
identifying, from the plurality of logical fields, at least one logical field having one or more allowed physical values defined by the physical data in the database;
retrieving a language resource component configured to transform the one or more allowed physical values into intermediate values defined in a third natural language; and
generating the user-defined function on the basis of the language resource component.

23. The computer-readable medium of claim 22, further comprising:
transforming the abstract query into an executable query capable of being executed against the database;
identifying a contribution defined for the at least one logical field in the executable query; and
associating the identified contribution in the executable query with the first language resource component, wherein the executable query is executed against the underlying database.

24. The computer-readable medium of claim 19, wherein the process further comprises:
receiving a request for further processing of the outputted query result;
retrieving a reverse language resource component configured to transform the alternative values included with the outputted query result into allowed physical values defined by the physical data in the underlying database;
transforming the alternative values of the outputted query result into corresponding allowed physical values using the reverse language resource component; and
outputting the query result including only physical values for further processing.
